(19) United States
(12) Patent Application Publication
(10) Pub. No.: US 2008/0077910 A1
(43) Pub. Date: Mar. 27, 2008

(54) Source code displaying program, source code displaying device, and source code displaying method

(75) Inventor: Yoshiyuki Ohta, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: Fujitsu Limited, Kawasaki-shi (JP)

(21) Appl. No.: 11/821,439

(22) Filed: Jun. 22, 2007

(30) Foreign Application Priority Data
Sep. 25, 2006 (JP) 2006-259477

(51) Int. Cl. G06F 9/44

(52) U.S. Cl. 717/113

(57) ABSTRACT

When a source code is designated, a software development device stores relation information that relates a comment to a token associated with the comment for each of comments in the source code into tables. The source code is displayed in a source code display frame under the condition where the comments are removed. When any portion in the displayed source code is dragged, a comment related to the dragged portion is displayed in the outline display frame.

### BACKGROUND OF THE INVENTION

The present invention relates to a source code displaying program that makes a computer function as a device displaying a source code, a source code displaying device that has the same function as such a computer on which the source code displaying program is running, and a source code displaying method that is implemented by such a source code displaying device.

According to a general software development method, binary codes of software are created by compiling and linking source codes written by a predetermined programming language. It is a known fact that various software development tools (software) have been developed to allow developers to do such operations.

A comment can be inserted into a source code while it is edited on such a software development tool. A comment has no effect on a logic that is represented by all statements in a source code. A comment is used to add information about a notice for a preprocessor in a source code, a statement, or a part of a statement, or information for assisting to grasp a statement.

A comment can be arranged at any position of a source code. In the C language, a comment can be inserted into a statement when it is sandwiched by tokens “/*” and “*/”. A comment can be written behind a statement by arranging a token “//”. A comment inserted into a statement as the former case is called a block comment, and a comment written behind a statement as the latter case is called a line comment.

For example, Japanese unexamined patent publications No. 06-067872, No. 05-100836, No. 08-272596, No. 07-234783, and No. 2005-122407 disclose a method for extracting a comment from a source program and editing it, and a method for analyzing a source program and creating a program design document and specification based on analyzed comments.

However, such a comment written in a source code interferes with a grasp of a statement, when logic of the source code is checked by grasping displayed statements in order.

For example, when many block-comments are inserted into a statement, the contents of the statement can not be grasped, which can disable a judgment as to what process is directed by the statement.

If a line that includes a line comment only without statements exists between lines that include statements, it takes time to grasp the statements in order.

Further, if there are many lines each of which includes line comments only in a screen when a source code is displayed, the number of statements on a display becomes small, which increases difficulty of confirmation of a logic throughout the source code.

Still further, a method to line up statements at the left of lines and to line up line comments at the right of lines can be adopted in order to improve an appearance of a source code. However, in this case, if there are many lines each of which includes line comments only, the left side becomes blank through a plurality of lines, which decreases the number of statements displayed in a screen.

Further, there is a technique to save a pre-update statement as a comment when a variable name, an argument name, or the like in the statement is updated so that the statement can be recovered to the pre-update condition easily. This technique is called the “comment-out”. However, when the comment-out is frequently used, many statements of which contents are slightly different are saved, which increases difficulty of judgment as to which statement is the latest-version.

There is a method that displays function names, include-file names, global declarations, and class names included in a source code as headwords in a display frame that is different from a display frame in which the source code is shown. Thus, the headwords shown in the display frame separated from a source code are called “outlines”. However, logic of the source code cannot be confirmed based on the outlines only.

### SUMMARY OF THE INVENTION

The present invention is achieved to solve the above mentioned problem of the prior art and an object thereof is to use comments effectively without interfering with confirmation of a logic of a source code.

A source code displaying program of the present invention is developed to achieve the above-mentioned object. The program makes a computer execute functions including: a reading function for reading, when a source code is designated among source codes that contain statements and comments through an input device, data of the designated source code from storage; an information creating function for creating relation information that relates a comment to a token associated with the comment for each of comments in the source code shown by the source code data read from the storage by the reading function, and for storing the created relation information into the storage; a source code displaying function for displaying a source code after removing comments in a first display frame based on the source code data read from the storage by the reading function; an accepting function for accepting a designation about any selected portion of the source code displayed in the first display frame by the source code displaying function, through the input device; and a first displaying function for reading, when the portion specified by the designation accepted by the accepting function is coincident with any token in the storage, the comment associated with this token from the storage, and for displaying the comment at a position corresponding to the position of the portion concerned in a second display frame.

With this configuration, the source code from which comments are removed can be displayed in the first display frame, and when any portion in the displayed source code is designated, the comment related with the portion is displayed in the second display frame. As a result, comments do not interfere with a confirmation of logic of a source code and the comments can be used effectively.

The source code displaying program of the present invention can include a second displaying function for extracting portions that have the same contents as the designated portion from a source code, and for displaying comments in all the positions of the extracted portions in the second display frame. As a result, a comment can be used more effectively.

A source code displaying device of the present invention is developed to achieve the above-mentioned object. The device including: a reading section for reading, when a source code is designated among source codes that contain statements and comments through an input device, data of the designated source code from storage; an information creating section for creating relation information that relates a comment to a token associated with the comment for each of comments in the source code shown by the source code data read from the storage by the reading section, and for storing the created relation information into the storage; a source code displaying section for displaying a source code after removing comments in a first display frame based on the source code data read from the storage by the reading section; an accepting section for accepting a designation about any selected portion of the source code displayed in the first display frame by the source code displaying section, through the input device; and a first displaying section for reading, when the portion specified by the designation accepted by the accepting section is coincident with any token in the storage, the comment associated with this token from the storage, and for displaying the comment at a position corresponding to the position of the portion concerned in a second display frame.

Therefore, the source code displaying device functions in the same manner as a computer on which the above-mentioned source code displaying program of the present invention is running. The source code displaying device also can include a second displaying section that has the same function as the above-mentioned second displaying function.

A source code displaying method of the present invention is developed to achieve the above-mentioned object. The method is implemented by a computer that executes procedures including: a reading procedure for reading, when a source code is designated among source codes that contain statements and comments through an input device, data of the designated source code from storage; an information creating procedure for creating relation information that relates a comment to a token associated with the comment for each of comments in the source code shown by the source code data read from the storage by the reading procedure, and for storing the created relation information into the storage; a source code displaying procedure for displaying a source code after removing comments in a first display frame based on the source code data read from the storage by the reading procedure; an accepting procedure for accepting a designation about any selected portion of the source code displayed in the first display frame by the source code displaying procedure, through the input device; and a first displaying procedure for reading, when the portion specified by the designation accepted by the accepting procedure is coincident with any token in the storage, the comment associated with this token from the storage, and for displaying the comment at a position corresponding to the position of the portion concerned in a second display frame.

Therefore, the device that implements the source code displaying method functions in the same manner as the above-mentioned source code displaying device of the present invention. The source code displaying method also can include a second displaying procedure that has the same function as the above-mentioned second displaying function.

As described above, according to the present invention, comments do not interfere with a confirmation of logic of a source code and the comments can be used effectively.

### DESCRIPTION OF THE ACCOMPANYING DRAWINGS

FIG. 1 is a block diagram of a software development device of an embodiment,

FIG. 2 shows an example of a source code expressed based on source code data,

FIG. 3 is a flowchart showing a process of a software development tool after startup thereof,

FIG. 4 through FIG. 7 are flowcharts showing a source code displaying process,

FIG. 8 shows an example of a data structure of a function structure management table,

FIG. 9 shows an example of a data structure of an argument management table,

FIG. 10 shows an example of a data structure of a variable management table,

FIG. 11 shows an example of a data structure of a return management table,

FIG. 12 shows an example of a data structure of an “abs” comment management table,

FIG. 13 shows an example of a data structure of a “ver” comment management table,

FIG. 14 shows an example of a data structure of an “oth” comment management table,

FIG. 15 shows an example of a data structure of an outline management table,

FIG. 16 through FIG. 19 are flowcharts showing an outline display process,

FIG. 20 shows an example of a data structure of outline data,

FIG. 21 is a flowchart showing a scroll process.

FIG. 22 through FIG. 25 are flowcharts showing a drag-related process,

FIG. 26 shows a condition where source code and outline are displayed on the respective display frames,

FIG. 27 shows a condition where a “ret” comment is highlighted, and

FIG. 28 shows a condition where respective comments are displayed in an outline display frame.

### DESCRIPTION OF THE PREFERRED EMBODIMENTS

Hereafter, the best mode to embody the present invention will be described in detail with reference to the attached drawings.

First, a configuration of a software development device of the embodiment is described.

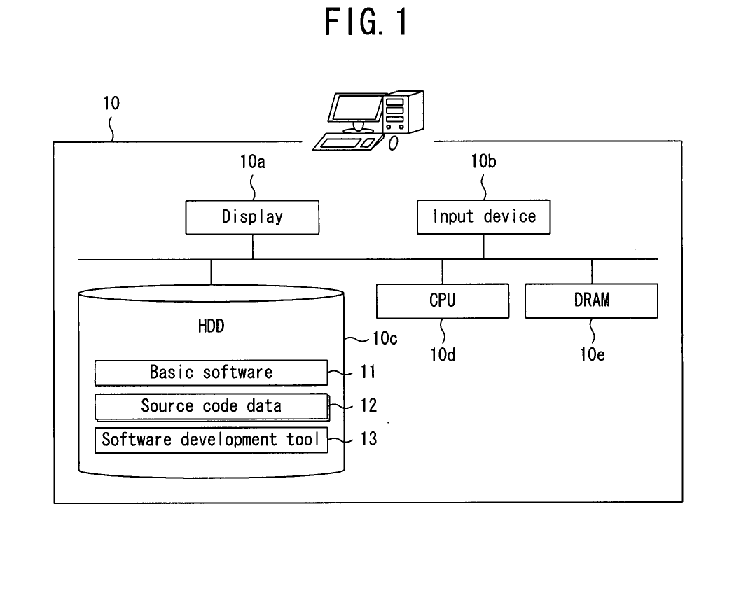

FIG. 1 is a block diagram of the software development device 10 of the embodiment.

As shown in FIG. 1, the software development device 10 is a common personal computer into which the below-mentioned program group and data group are installed. As everyone knows, the personal computer consists of a display 10a such as a liquid crystal display, input devices 10b such as a keyboard and a mouse, and a main body to which these devices 10a and 10b are connected. The main body contains hardware such as an HDD (Hard Disk Drive) 10c, a CPU (Central Processing Unit) 10d, and a DRAM (Dynamic Random Access Memory) 10e. The HDD10c is storage that stores various programs and data. The CPU 10d is a control device that performs various kinds of processes according to the programs in the HDD10c, and the DRAM 10e is a volatile storage. When the CPU 10d performs a process according to a program, a workspace is developed on the DRAM 10e.

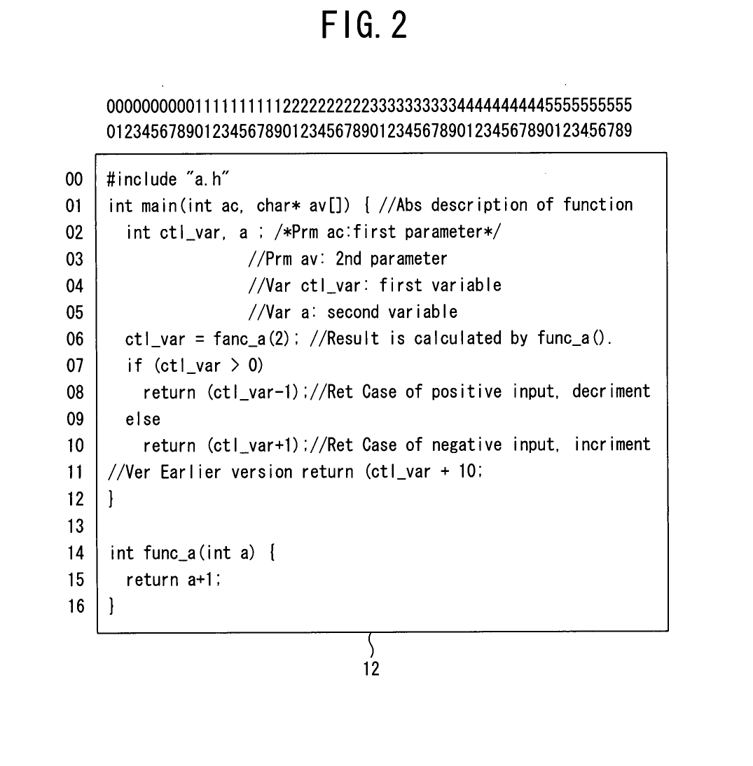

The HDD 10c of the software development device 10 stores basic software 11, source code data 12, and a software development tool 13. The basic software 11 manages input and output of the display 10a and the input devices 10b, manages storage areas of the HDD 10c and the DRAM 10e, and provides a fundamental function called GUI (Graphical User Interface) to many applications. The source code data 12 is text data that consist of words and phrases of the predetermined programming language that are combined in accordance with the grammar of the language. Here, FIG. 2 shows an example of a source code that is expressed based on the source code data 12. The source code shown in FIG. 2 is based on the C language. FIG. 2 includes line numbers, which show positions counted from the top line, and column numbers, which show positions counted from the left edge. These line numbers and column numbers are shown for convenience, and they do not constitute the source code. The software development tool 13 is software to implement an editing function of a source code and a creating function of a binary code on the personal computer concerned. The binary code creating function includes a compiler for compiling source codes and a linker for linking object codes generated by the compiler, as everyone knows. Although neither the compiler nor the linker is illustrated, they are implemented by modular programs for exhibiting these functions.

Next, the contents of the process that are executed by the software development device 10 are described.

When the software development tool 13 is started in response to an operation of the input devices 10b by an operator, the CPU 10d reads the software development tool 13 and starts the process.

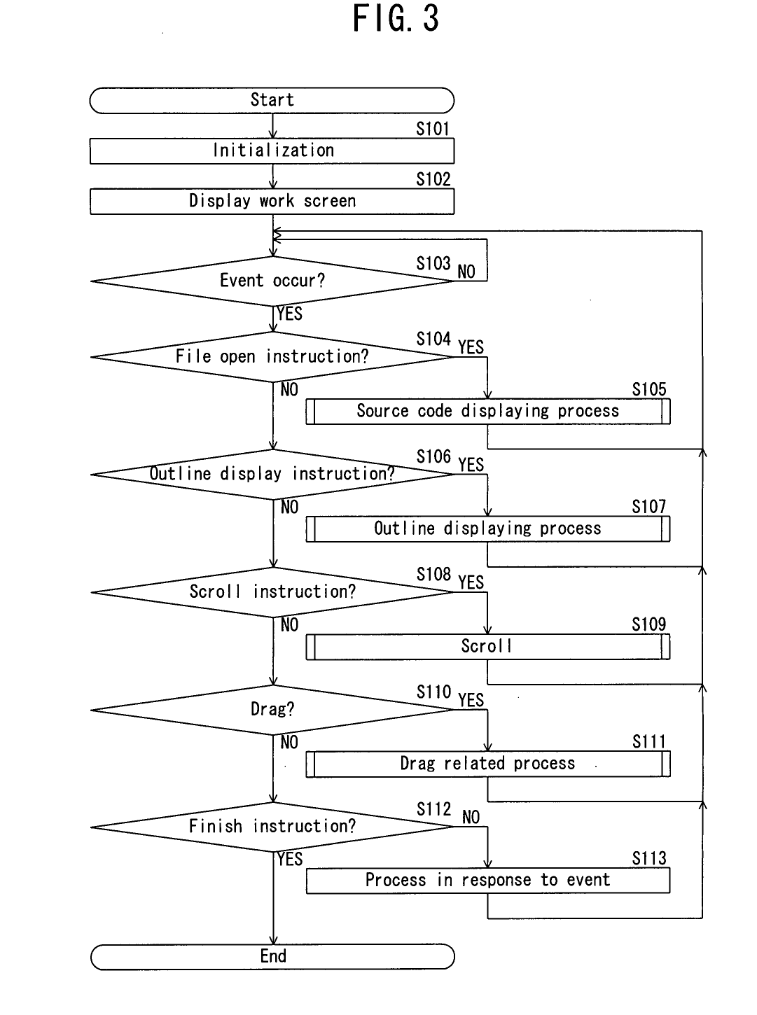

FIG. 3 is a flowchart showing a process of the software development tool 13 concerned after startup thereof.

At the first step S101 of the process, the CPU 10d executes an initialization. In the initialization, zero is substituted into each of below-mentioned variables used in later processes.

In the next step S102, the CPU 10d displays a work screen on the display 10a. The work screen includes a source code display frame for displaying a source code and an outline display frame for displaying any characters in a source code as headings. However, at this time, both of the display frames are displayed only on the work screen, and nothing is displayed in both of the display frames. In this work screen, a button for inputting an instruction to open any file is included.

In the next step S103, the CPU 10d waits until an event occurs, and advances the process to step S104 when an event occurs.

In step S104, the CPU 10d determines whether the event is an instruction to open a file. When the event is the instruction to open a file, the CPU 10d branches the process from step S104 to step S105.

In step S105, the CPU 10d executes a source code displaying process.

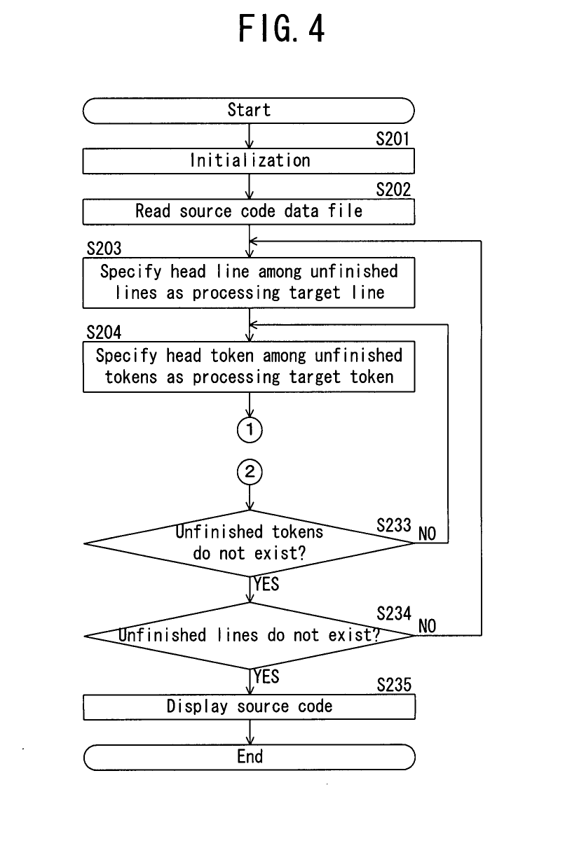

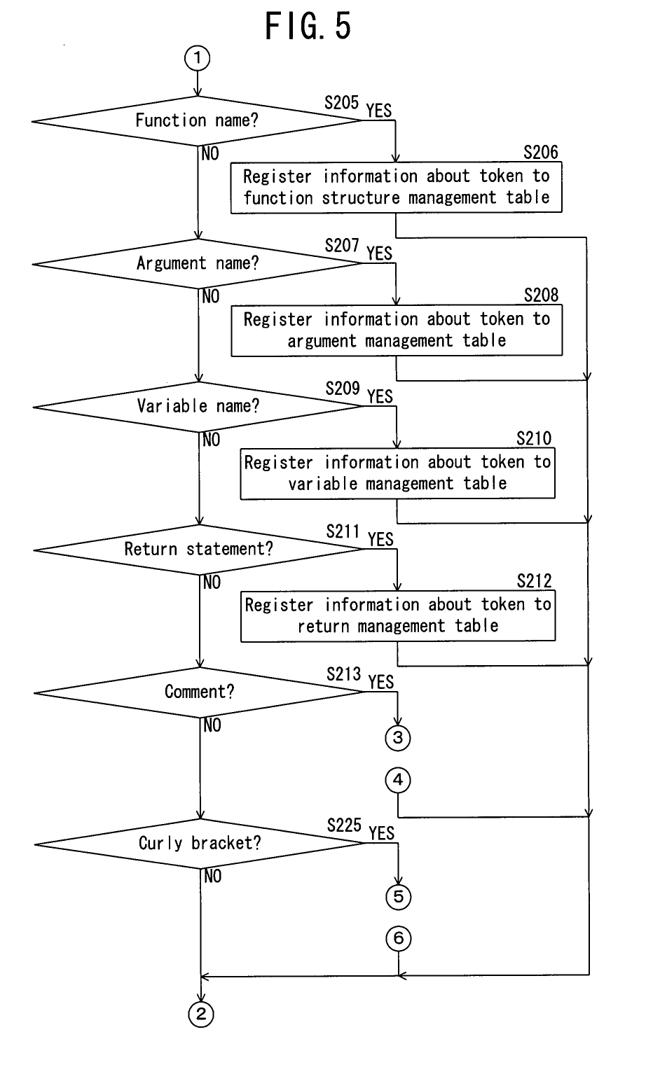

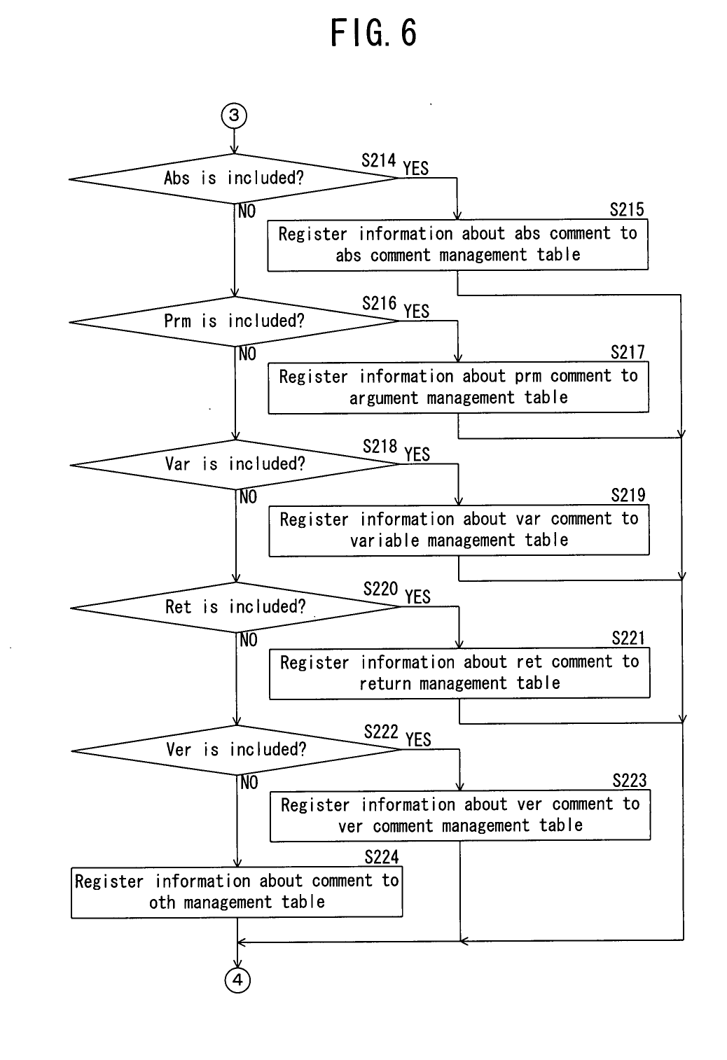

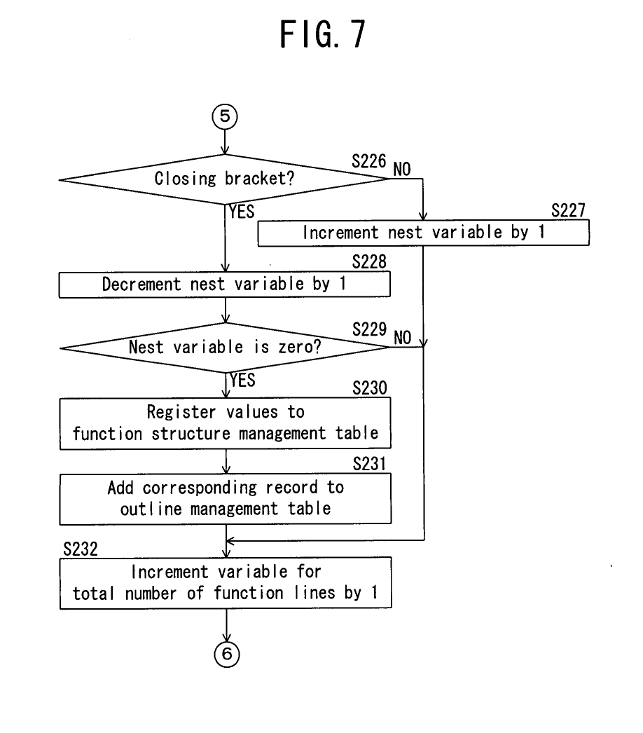

FIGS. 4 through 7 are flowcharts showing the source code displaying process.

At first step S201 of the source code displaying process, the CPU 10d executes an initialization. In the initialization, zero is substituted into each of below-mentioned variables used in later processes, and below-mentioned respective tables used in later processes are newly generated.

In the next step S202, the CPU 10d reads a file of the instructed source code data 12 from the HDD 10c. After executing this process, the CPU 10d advances the process to step S203.

The CPU 10d that executes steps S102, S103, and S202 corresponds to the above-mentioned reading function and reading section. Steps S102, S103, and S202 correspond to the reading procedure mentioned above.

In step S203, the CPU 10d focuses on the head line among the lines of unfinished source code data as a processing target line.

In the next step S204, the CPU 10d specifies the head token among unfinished tokens in the processing target line as a processing target token. A token means a letter that constitutes a statement in a source code. More specifically, a token includes /*, */, (, ), “, ;, {, }, //, an operator, a function name, a variable name, an argument name, a control statement, etc. A comment itself written between the tokens /* and */, and a comment itself written behind the token // are irrelevant to statements and are not grasped by a compiler. Therefore, such a comment is not called a token to be exact. However, a comment is also treated as a token in this specification for convenience.

In the next step S205, the CPU 10d determines whether the processing target token is a function name. Specifically, the CPU 10d determines whether the following two conditions are satisfied: (1) The substitution value of a nest variable is zero. (2) The processing target token is located between a left round bracket and a type name such as “int”, “char”, and “float”. The substitution value of the nest variable represents levels of nested brackets. When the processing target token is a function name, the CPU 10d branches the process from step S205 to step S206.

In step S206, the CPU 10d registers the information about the processing target token into a function structure management table. The function structure management table is used to manage the information about the functions included in the source code concerned.

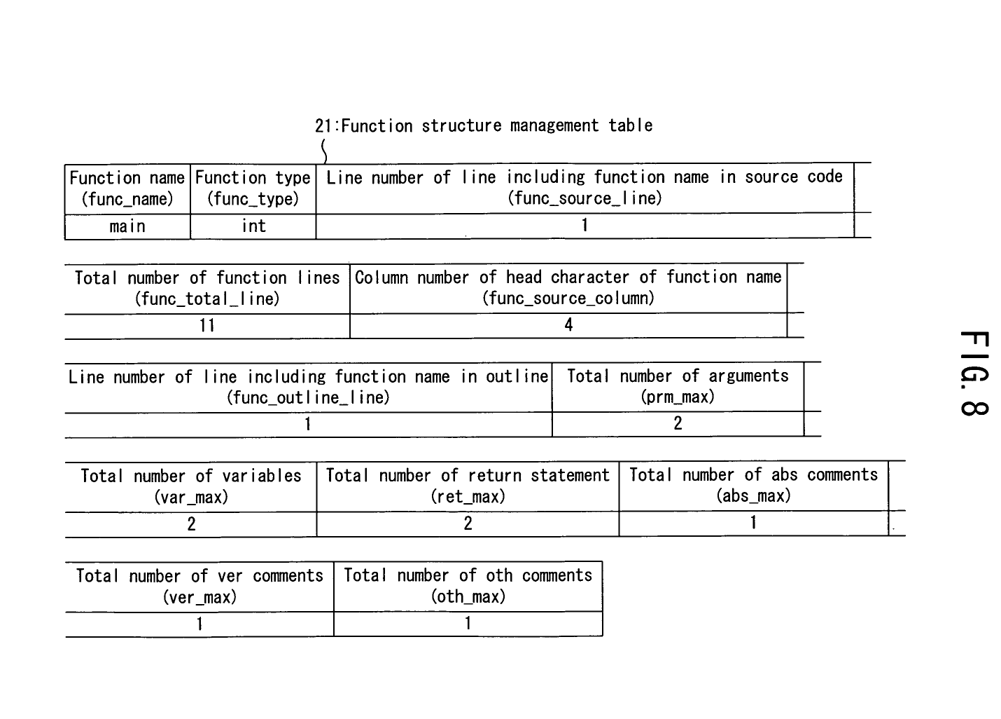

FIG. 8 shows an example of the data structure of the function structure management table 21.

As shown in FIG. 8, each record in the function structure management table 21 contains fields of “function name”, “function type”, “line number of line including function name in source code”, “total number of function lines”, “column number of head character of function name”, “line number of line including function name in outline”, “total number of arguments”, “total number of variables”, “total number of return statements”, “total number of abs comments”, “total number of ver comments”, and “total number of oth comments”. (Abs comments, ver comments, and oth comments are described later.)

A name of a function is recorded in the “function name” field. A name of a function type that is defined as a return value type of the function is recorded in the “function type” field. A line number of a line on which the function name exists among the line numbers defined for the respective lines in the source code is stored in the “line number of line including function name in source code” field. A body of a function is described between a pair of curly brackets. The opening curly bracket is located behind the function name and the closing curly bracket is located at the end of the function. The number of lines from a line on which the function name exists to a line on which the closing curly bracket exists is stored in the “total number of function lines” field. The column number of the head character of the function name among the column numbers defined for the respective columns on the line including the function name is stored in the “column number of head character of function name” field. The line number of the line including the function name among the line numbers defined for the respective lines in the outline is recorded in the “line number of line including function name in outline” field. The number of arguments described between a pair of round brackets just behind the function is recorded in the “total number of arguments” field. The number of variables within the body of the function described between a pair of curly brackets is recorded in the “total number of variables” field. The number of return statements within the body of the function described between a pair of curly brackets is recorded in the “total number of return statements” field. The number of abs comments described in all the lines including the function name and the function body is recorded in the “total number of abs comments” field. The abs comment is the comment that begins with a character string “abs”. The character string “Abs” is incorporated in advance by the author of the source code. The number of ver comments described in all the lines including the function name and the function body is recorded in the “total number of ver comments” field. The ver comment is the comment that begins with a character string “ver”. The character string “Ver” is also incorporated in advance by the author of the source code. The number of comments, which do not include the predetermined character strings (“Abs”, “Ver”, etc.), described in all the lines including the function name and the function body is recorded in the “total number of oth comments” field.

Although the CPU 10d registers the information about the processing target token into the function structure management table 21 as shown in FIG. 8, values are recorded in the fields of “function name”, “function type”, “line number of line including function name in source code”, and “column number of head character of function name” at this time. The other fields are blank. After the registration process, the CPU 10d advances the process to step S233.

On the other hand, if the processing target token is not a function name in step S205, the CPU 10d advances the process to step S207.

In step S207, the CPU 10d determines whether the processing target token is an argument name. Specifically, the CPU 10d determines whether the processing target token exists between a pair of round brackets just behind the function name. And when the processing target token is an argument name, the CPU 10d branches the process from step S207 to step S208.

In step S208, the CPU 10d registers the information about the processing target token to the argument management table. The argument management table is the table used to manage the information about the argument (parameter value) of a function included in the source code concerned.

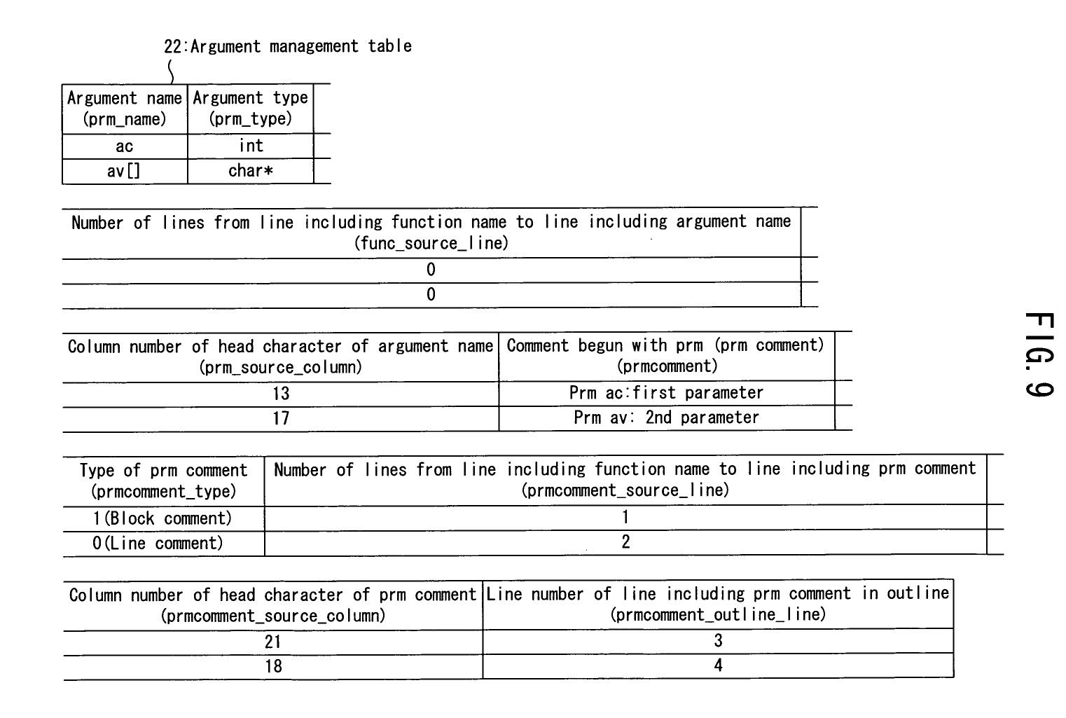

FIG. 9 shows an example of the data structure of the argument management table 22.

As shown in FIG. 9, each record of the argument management table 22 contains the fields of “argument name”, “argument type”, “number of lines from line including function name to line including argument name”, “column number of head character of argument name”, “comment begun with prm (prm comment)”, “type of prm comment”, “number of lines from line including function name to line including prm comment”, “column number of head character of prm comment”, and “line number of line including prm comment in outline”.

A name of an argument is recorded in the “argument name” field. A name of an argument type that is defined as a variable-type name of the argument is recorded in the “argument type” field. The number of lines calculated by subtracting the line number of the line including the function name from the line number of the line including the argument name is recorded in the “number of lines from line including function name to line including argument name” field. The column number of the head character of the argument name among the column numbers defined for the respective columns on the line including the argument name is recorded in the “column number of head character of argument name” field. The contents of the prm comment are recorded in the “comment begun with prm (prm comment)” field. The prm comment is the comment that begins with a character string “Prm”. This character string “Prm” is incorporated in advance by the author of the source code. In the “type of prm comment” field, “0” that represents the prm comment is a line comment or “1” that represents the prm comment is a block comment is recorded. The number of lines calculated by subtracting the line number of the line including the function name from the line number of the line including the prm comment is recorded in the “number of lines from line including function name to line including prm comment” field. The column number of the head character of the prm comment among the column numbers defined for the respective columns on the line including the prm comment is recorded in the “column number of head character of prm comment” field. The line number of the line including the prm comment among the line numbers defined for the respective lines in the outline is recorded in the “line number of line including prm comment in outline” field.

Although the CPU 10d registers the information about the processing target token into the function structure management table 21 as shown in FIG. 9, values are recorded in the fields of “argument name”, “argument type”, “number of lines from line including function name to line including argument name”, and “column number of head character of argument name” at this time. The other fields are blank. After the registration process, the CPU 10d advances the process to step S233.

On the other hand, if the processing target token is not an argument of a function in step S207, the CPU 10d advances the process to step S209.

In step S209, the CPU 10d determines whether the processing target token is a variable name. Specifically, the CPU 10d determines whether the following three conditions are satisfied: (1) The substitution value of a nest variable is equal to or larger than 1. (2) The processing target token is located between a type name and a semicolon “;”. (3) An opening round bracket does not exist between a type name and a semicolon. And when the processing target token is a variable name, the CPU 10d branches the process from step S209 to step S210.

In step S210, the CPU 10d registers the information about the processing target token into the variable management table. The variable management table is used to manage the information about the variable included in the source code concerned.

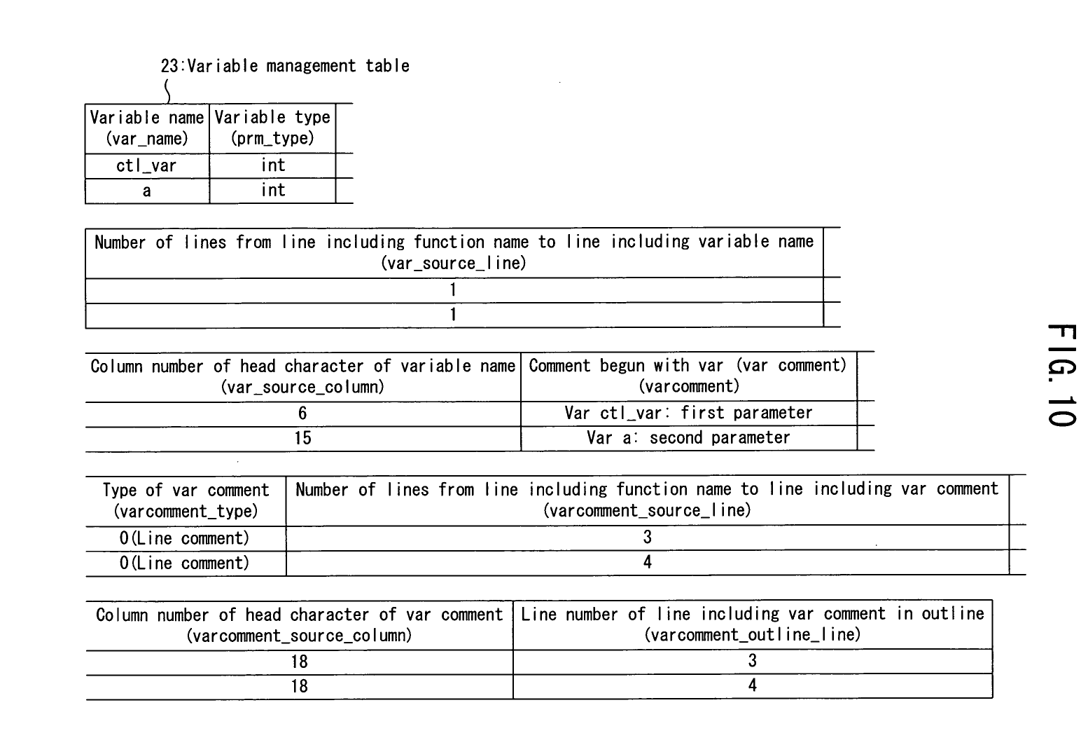

FIG. 10 shows an example of the data structure of the variable management table 23.

As shown in FIG. 10, each record in the variable management table 23 contains fields of “variable name”, “variable type”, “number of lines from line including function name to line including variable name”, “column number of head character of variable name”, “comment begun with var (var comment)”, “type of var comment”, “number of lines from line including function name to line including var comment”, “column number of head character of var comment”, and “line number of line including var comment in outline”.

A name of a variable is recorded in the “variable name” field. A name of a variable type that is defined as a type of value substituted to the variable is recorded in the “variable type” field. The number of lines calculated by subtracting the line number of the line including the function name from the line number of the line including the variable name is recorded in the “number of lines from line including function name to line including variable name” field. The column number of the head character of the variable name among the column numbers defined for the respective columns on the line including the variable name is recorded in the “column number of head character of variable name” field. The contents of the var comment are recorded in the “comment begun with var (var comment)” field. The var comment is the comment that begins with a character string “Var”. This character string “Var” is incorporated in advance by the author of the source code. In the “type of var comment” field, “0” that represents the var comment is a line comment or “1” that represents the var comment is a block comment is recorded. The number of lines calculated by subtracting the line number of the line including the function name from the line number of the line including the var comment is recorded in the “number of lines from line including function name to line including var comment” field. The column number of the head character of the var comment among the column numbers defined for the respective columns on the line including the var comment is recorded in the “column number of head character of var comment” field. The line number of the line including the var comment among the line numbers defined for the respective lines in the outline is recorded in the “line number of line including var comment in outline” field.

Although the CPU 10d registers the information about the processing target token into the function structure management table 23 as shown in FIG. 10, values are recorded in the fields of “variable name”, “variable type”, “number of lines from line including function name to line including variable name”, and “column number of head character of variable name” at this time. The other fields are blank. After the registration process, the CPU 10d advances the process to step S233.

On the other hand, if the processing target token is not a variable name in step S209, the CPU 10d advances the process to step S211.

In step S211, the CPU 10d determines whether the processing target token is a “return” statement. And when the processing target token is the “return” statement, the CPU 10d branches the process from step S211 to step S212.

In step S212, the CPU 10d registers the information about the processing target token into the return management table. The return management table is used to manage the information about the return included in the source code concerned.

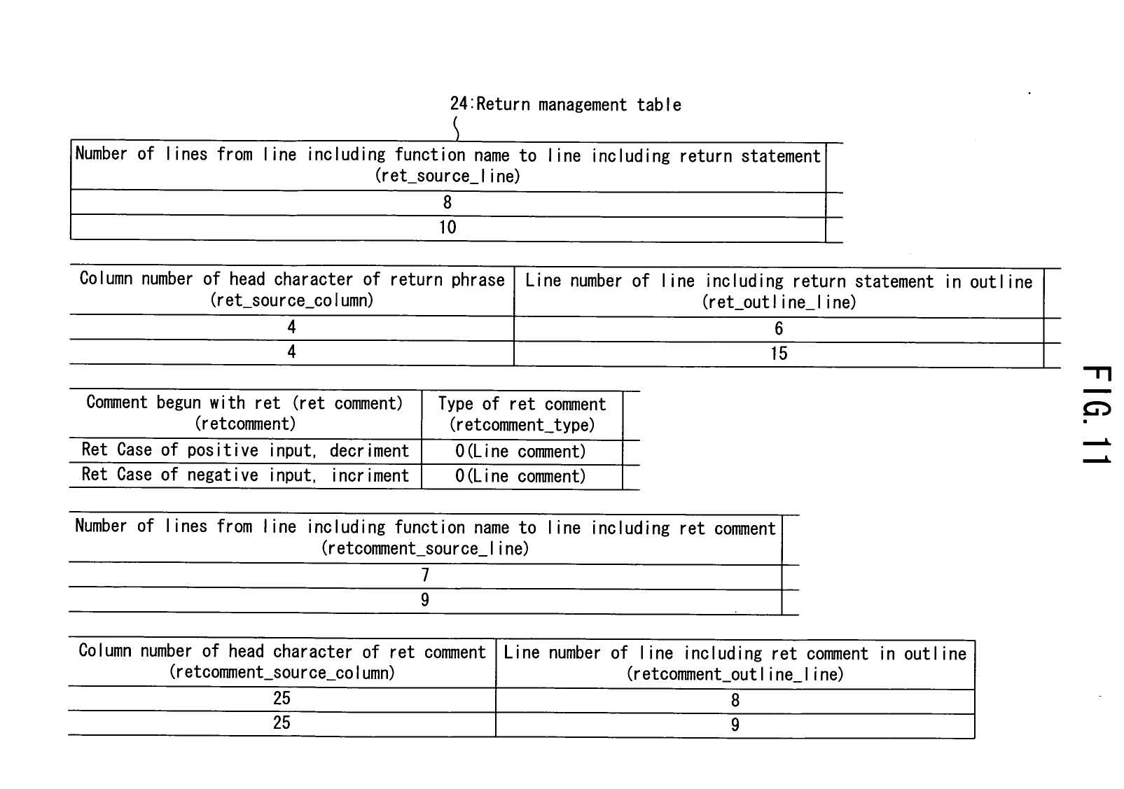

FIG. 11 shows an example of the data structure of the return management table 24.

As shown in FIG. 11, each record in the return management table 24 contains fields of “number of lines from line including function name to line including return statement”, “column number of head character of return statement”, “line number of line including return statement in outline”, “comment begun with ret (ret comment)”, “type of ret comment”, “number of lines from line including function name to line including ret comment”, “column number of head character of ret comment”, and “line number of line including ret comment in outline”.

The number of lines calculated by subtracting the line number of the line including the function name from the line number of the line including the return statement is recorded in the “number of lines from line including function name to line including return statement” field. The column number of the head character of the return statement among the column numbers defined for the respective columns on the line including the return statement is recorded in the “column number of head character of return statement” field. The line number of the line including the return statement among the line numbers defined for the respective lines in the outline is recorded in the “line number of line including return statement in outline” field. The contents of the ret comment are recorded in the “comment begun with ret (ret comment)” field. The ret comment is the comment that begins with a character string “Ret”. This character string “Ret” is incorporated in advance by the author of the source code. In the “type of ret comment” field, “0” that represents the ret comment is a line comment or “1” that represents the ret comment is a block comment is recorded. The number of lines calculated by subtracting the line number of the line including the function name from the line number of the line including the ret comment is recorded in the “number of lines from line including function name to line including ret comment” field. The column number of the head character of the ret comment among the column numbers defined for the respective columns on the line including the ret comment is recorded in the “column number of head character of ret comment” field. The line number of the line including the ret comment among the line numbers defined for the respective lines in the outline is recorded in the “line number of line including ret comment in outline” field.

Although the CPU 10d registers the information about the processing target token into the return management table 24 as shown in FIG. 11, values are recorded in the fields of “number of lines from line including function name to line including return statement” and “column number of head character of return statement” at this time. The other fields are blank. After the registration process, the CPU 10d advances the process to step S233.

The CPU 10d that executes steps S205 through S212 corresponds to the above-mentioned information creating function and information creating section. Steps S205 through S212 correspond to the above-mentioned information creating procedure.

On the other hand, if the processing target token is not a return statement in step S211, the CPU 10d advances the process to step S213.

In step S213, the CPU 10d determines whether the processing target token is a comment. Specifically, the CPU 10d determines whether a character string is a line comment by checking whether it is located just behind “//”, and determines whether a character string is a block comment by checking whether it is located between “/*” and “*/”. And when the processing target token is a comment, the CPU 10d branches the process from step S213 to step S214.

In step S214, the CPU 10d determines whether the character string of “Abs” is included in the head of the comment. And when the comment begins with a character string “Abs”, the CPU 10d branches the process from step S214 to step S215.

In step S215, the CPU 10d registers information about the abs comment that begins with the character string “Abs” into the abs comment management table. The abs comment management table is used to manage the information about the abs comment included in the source code concerned.

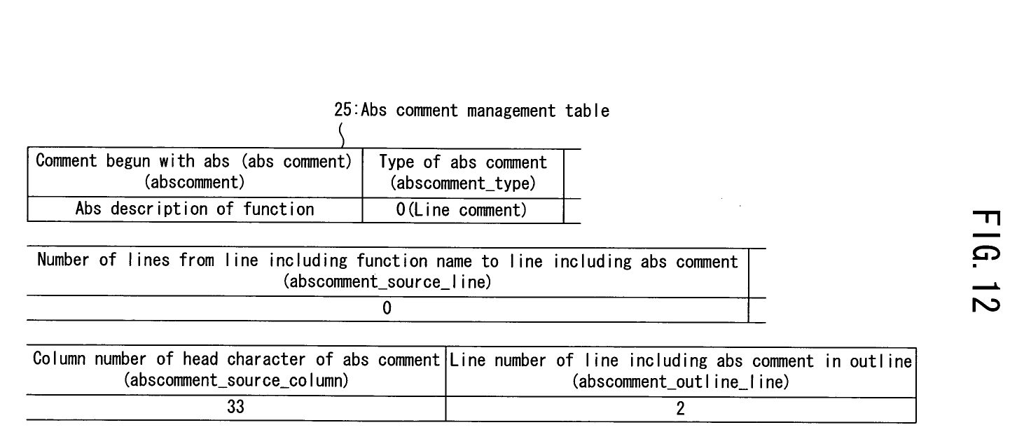

FIG. 12 shows an example of the data structure of the abs comment management table 25.

As shown in FIG. 12, each record of the abs comment management table 25 contains fields of “comment begun with abs (abs comment)”, “type of abs comment”, “number of lines from line including function name to line including abs comment”, “column number of head character of abs comment”, and “line number of line including abs comment in outline”.

The contents of the abs comment are recorded in the “comment begun with abs (abs comment)” field. This character string “Abs” is incorporated in advance by the author of the source code. In the “type of abs comment” field, “0” that represents the abs comment is a line comment or “1” that represents the abs comment is a block comment is recorded. The number of lines calculated by subtracting the line number of the line including the function name from the line number of the line including the abs comment is recorded in the “number of lines from line including function name to line including abs comment” field. The column number of the head character of the abs comment among the column numbers defined for the respective columns on the line including the abs comment is recorded in the “column number of head character of abs comment” field. The line number of the line including the abs comment among the line numbers defined for the respective lines in the outline is recorded in the “line number of line including abs comment in outline” field.

After registering information about the processing target token (abs comment) into the abs comment management table 25 as shown in FIG. 12, the CPU 10d advances the process to step S233.

On the other hand, when the comment does not begin with the character string “Abs” in step S214, the CPU 10d advances the process to step S216.

In step S216, the CPU 10d determines whether the character string of “Prm” is included in the head of the comment. And when the comment begins with a character string “Prm”, the CPU 10d branches the process from step S216 to step S217.

In step S217, the CPU 10d registers information about the prm comment that begins with the character string “Prm” into the argument management table 22 shown in FIG. 9. The argument name is included in the prm comment concerned. Therefore, the CPU 10d searches the argument management table 22 for a record that matches the argument name and whose fields “comment begun with prm (prm comment)”, “type of prm comment”, “number of lines from line including function name to line including prm comment”, “column number of head character of prm comment” and “line number of line including prm comment in outline” are blank. Then, the CPU 10d stores the corresponding values into the respective fields of the detected record. After the registration process, the CPU 10d advances the process to step S233.

On the other hand, when the comment does not begin with the character string “Prm” in step S216, the CPU 10d advances the process to step S218.

In step S218, the CPU 10d determines whether the character string of “Var” is included in the head of the comment. And when the comment begins with the character string “Var”, the CPU 10d branches the process from step S218 to step S219.

In step S219, the CPU 10d registers information about the var comment that begins with the character string “Var” into the variable management table 23 shown in FIG. 10. The variable name is included in the var comment concerned. Therefore, the CPU 10d searches the variable management table 23 for a record that matches the variable name and whose fields “comment begun with var (var comment)”, “type of var comment”, “number of lines from line including function name to line including var comment”, “column number of head character of var comment” and “line number of line including var comment in outline” are blank. Then, the CPU 10d stores the corresponding values into the respective fields of the detected record. After the registration process, the CPU 10d advances the process to step S233.

On the other hand, when the comment does not begin with the character string “Var” in step S218, the CPU 10d advances the process to step S220.

In step S220, the CPU 10d determines whether the character string of “Ret” is included in the head of the comment. And when the comment begins with the character string “Ret”, the CPU 10d branches the process from step S220 to step S221.

In step S221, the CPU 10d registers information about the ret comment that begins with the character string “Ret” into the return management table 24 shown in FIG. 11. At this time, the CPU 10d searches the return management table 24 for a record that is located in the same line as the ret comment concerned. Then, the CPU 10d stores the corresponding values to the fields “comment begun with ret (ret comment)”, “type of ret comment”, “number of lines from line including function name to line including ret comment”, and “column number of head character of ret comment” of the detected record. After the registration process, the CPU 10d advances the process to step S233.

On the other hand, when the comment does not begin with the character string “Ret” in step S220, the CPU 10d advances the process to step S222.

In step S222, the CPU 10d determines whether the character string of “Ver” is included in the head of the comment. And when the comment begins with the character string “Ver”, the CPU 10d branches the process from step S222 to step S223.

In step S223, the CPU 10d registers information about the ver comment that begins with the character string “Ver” into the ver comment management table. The ver comment management table is used to manage the information about the ver comment included in the source code concerned.

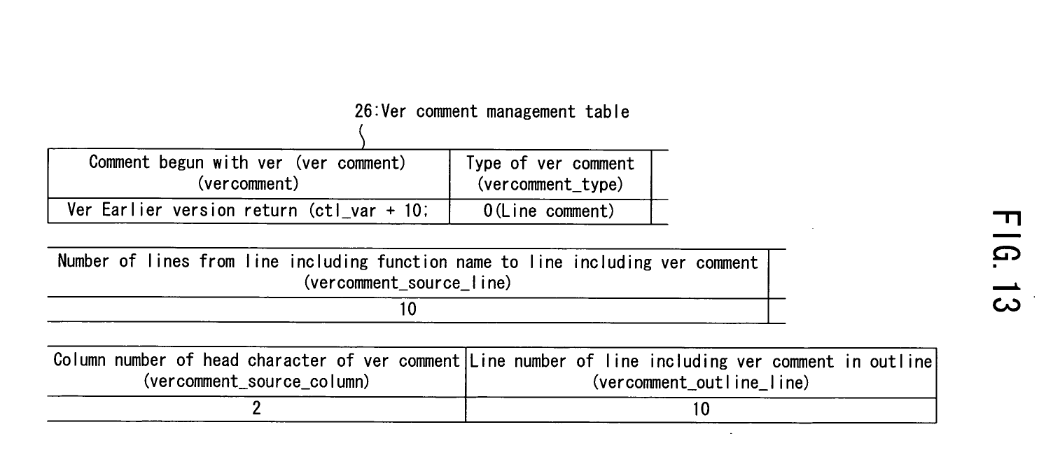

FIG. 13 shows an example of the data structure of the ver comment management table 26.

As shown in FIG. 13, each record of the ver comment management table 26 contains fields of “comment begun with ver (ver comment)”, “type of ver comment”, “number of lines from line including function name to line including ver comment”, “column number of head character of ver comment”, and “line number of line including ver comment in outline”. The ver comment management table 26 in FIG. 13 has the same structure as the abs comment management table 25 in FIG. 12. Semantically, each field's name of the ver comment management table 26 in FIG. 13 is composed of “ver” instead of “abs”. The meaning of each field of the ver comment management table 26 is the same as that of the abs comment management table 25 in FIG. 12.

After registering the information about the processing target token (ver comment) into the ver comment management table 26 as shown in FIG. 13, the CPU 10d advances the process to step S233.

On the other hand, when the comment does not begin with the character string “Ver” in step S222, the CPU 10d advances the process to step S224.

In step S224, the CPU 10d registers the information about the comment concerned into the oth comment management table. The oth comment management table is used to manage the information about a comment, which corresponds to none of abs comment, prm comment, var comment, ret comment, and ver comment, in the source code.

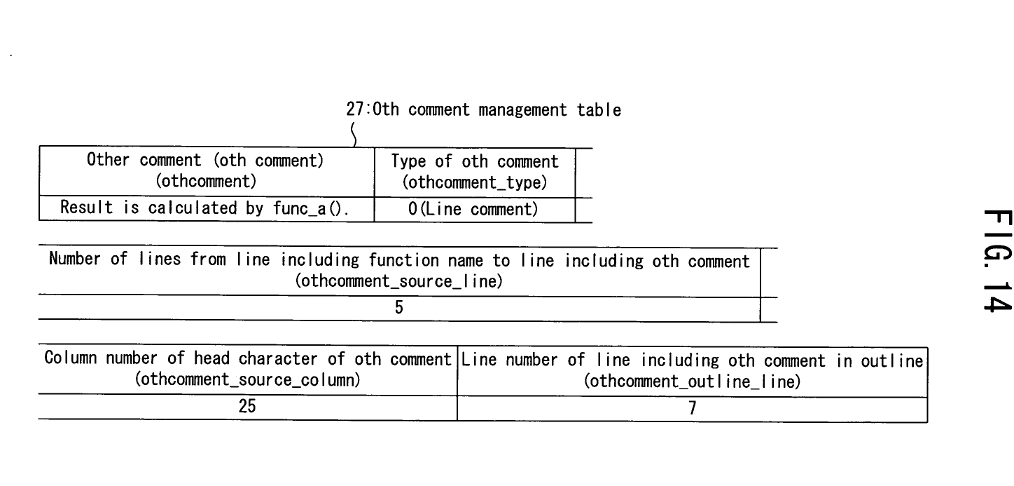

FIG. 14 shows an example of the data structure of the oth comment management table 27.

As shown in FIG. 14, each record of the oth comment management table 27 contains fields of “other comment (oth comment)”, “type of oth comment”, “number of lines from line including function name to line including oth comment”, “column number of head character of oth comment”, and “line number of line including oth comment in outline”. The oth comment management table 27 in FIG. 14 has the same structure as the abs comment management table 25 in FIG. 12. Semantically, each field's name of the oth comment management table 27 in FIG. 14 is composed of “oth” enstead of “abs”. The meaning of each field is the same as that of the abs comment management table 25 in FIG. 12.

After registering the information about the processing target token (oth comment) into the oth comment management table 27 as shown in FIG. 14, the CPU 10d advances the process to step S233.

On the other hand, when the processing target token is not a comment in step S213, the CPU 10d advances the process to step S225.

In step S225, the CPU 10d determines whether the processing target token is a curly bracket. And when the processing target token is a curly bracket, the CPU 10d branches the process from step S225 to step S226.

In step S226, the CPU 10d determines whether the processing target token is a closing bracket. And when the processing target token is not a closing bracket, the CPU 10d branches the process from step S226 to step S227.

In step S227, the CPU 10d increments a substitution value of the nest variable by 1. After executing such a process, the CPU 10d advances the process to step S233.

On the other hand, when the processing target token is a closing bracket in step S226, the CPU 10d advances the process to step S228.

In step S228, the CPU 10d decrements a substitution value of the nest variable by 1. Then, the CPU 10d advances the process to step S229.

In step S229, the CPU 10d determines whether the substitution value of the nest variable is zero. And when the substitution value of the nest variable is not zero, the CPU 10d branches the process from step S229 to step S233. When the substitution value of the nest variable is zero, it advances the process to step S230.

In step S230, the CPU 10d registers the corresponding value to each of fields “total number of function lines”, “total number of arguments”, “total number of variables”, “total number of return statements”, “total number of abs comments”, “total number of ver comments”, and “total number of oth comments” of the latest record in the function structure management table 21 in FIG. 8. Each of the values is calculated based on the information recorded in the respective tables 22 through 27 shown in FIGS. 9 through 14.

In the next step S231, the CPU 10d adds a corresponding record to the outline management table. The outline management table is used to manage the headings displayed in the outline display frame.

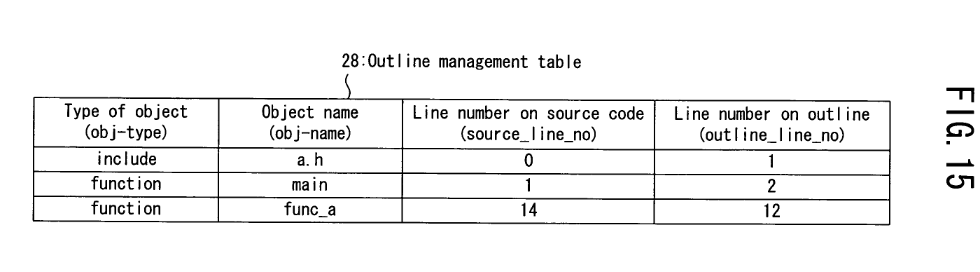

FIG. 15 shows an example of the data structure of the outline management table 28.

As shown in FIG. 15, each record of the outline management table 28 contains fields of “type of object”, “object name”, “line number on source code”, and “line number on outline”.

A type of the object is recorded in the “type of object” field. The object's name is recorded in the “object name” field. The line number of the line including the object in the source code is recorded in the “line number on source code” field. The line number of the line including the object in the outline is recorded in the “line number on outline” field.

Although the CPU 10d registers the information about the function name used as the latest processing target into the outline management table 28 in step S231, it registers #include, which is a object other than function names, according to a separate process (not shown). At this step S231, values are stored in the fields other than the “line number on outline” field of the record registered in the outline management table 28. The “line number on outline” field remains blank. After registering the function name into the outline management table 28, the CPU 10d advances the process to step S232.

In step S232, the CPU 10d increments the substitution value of the variable for the total number of function lines by 1 and advances the process to step S233 in FIG. 4.

On the other hand, when the processing target token is not a curly bracket in step S225, the CPU 10d advances the process to step S233 from step S225.

In step S233, the CPU 10d determines whether the there are other tokens in the processing target line. And when an unfinished token exists in the processing target line, the CPU 10d branches the process from step S233, and returns the process to step S204. On the other hand, when the processes for all the tokens have been finished, the CPU 10d advances the process to step S234.

In step S234, the CPU 10d determines whether an unfinished line exists in the source code data. And when an unfinished line exists in the source code data, the CPU 10d branches the process from step S234, and returns the process to step S203. On the other hand, when all the lines have been processed, the CPU 10d advances the process to step S235.

In step S235, the CPU 10d displays the source code on the source code display frame based on the source code data read in step S202. In this process, the CPU 10d displays the source code on the source code display frame after removing comments (both of line comments and block comments) in the source code. After executing such a process, the CPU 10d finishes the source code displaying process concerning FIGS. 4 through 7.

The CPU 10d that executes step S235 corresponds to the above-mentioned source code displaying function and source code displaying section. Further, step S235 corresponds to the above-mentioned source code displaying procedure.

After finishing the source code displaying process of FIGS. 4 through 7, the CPU 10d returns the process to step S103 from step S105 in FIG. 3.

On the other hand, when the event detected in step S103 is not an instruction to open a file in step S104, the CPU 10d advances the process to step S106 from step S104.

In step S106, the CPU 10d determines whether the event is an instruction to display an outline. And when the event is an instruction to display an outline, the CPU 10d branches the process from step S106 to step S107. However, when the source code is not displayed on the source code display frame, it is impossible to display an outline. In such a case, the CPU 10d skips step S106 and advances the process to step S108.

In step S107, the CPU 10d executes an outline displaying process.

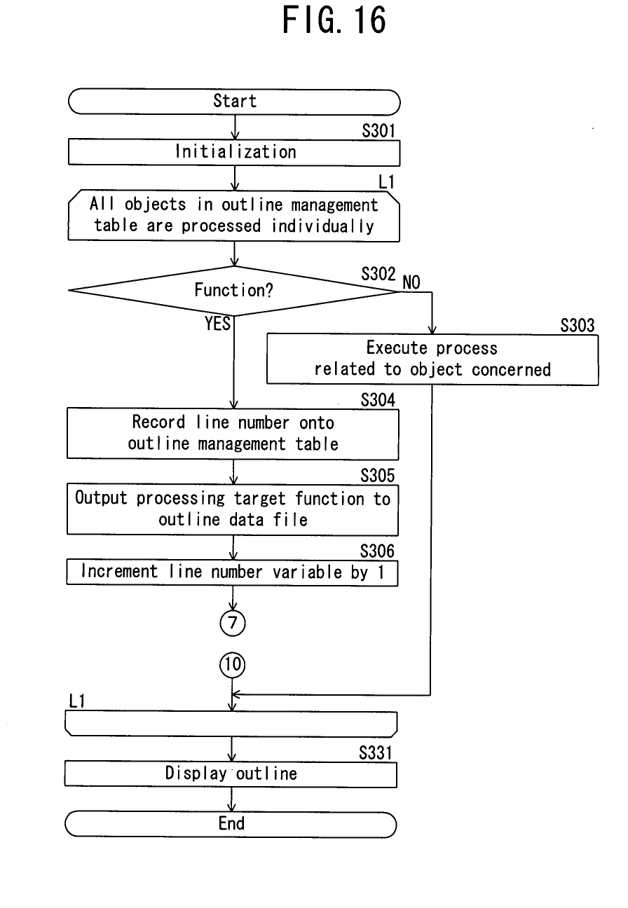

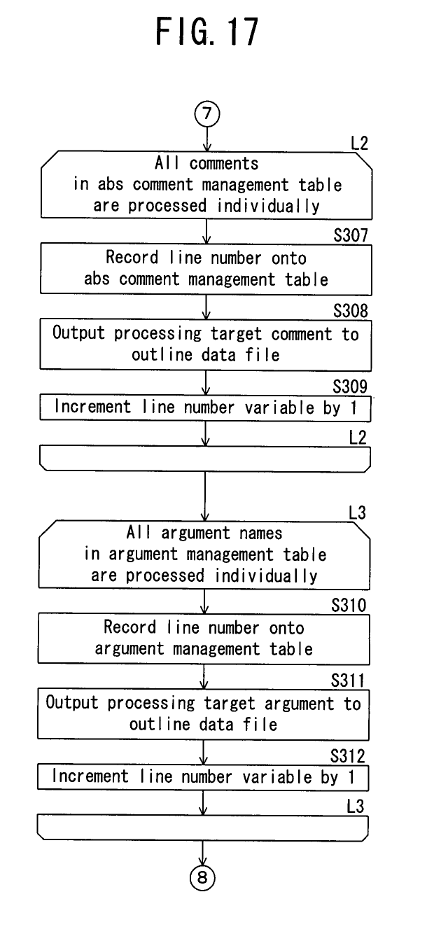

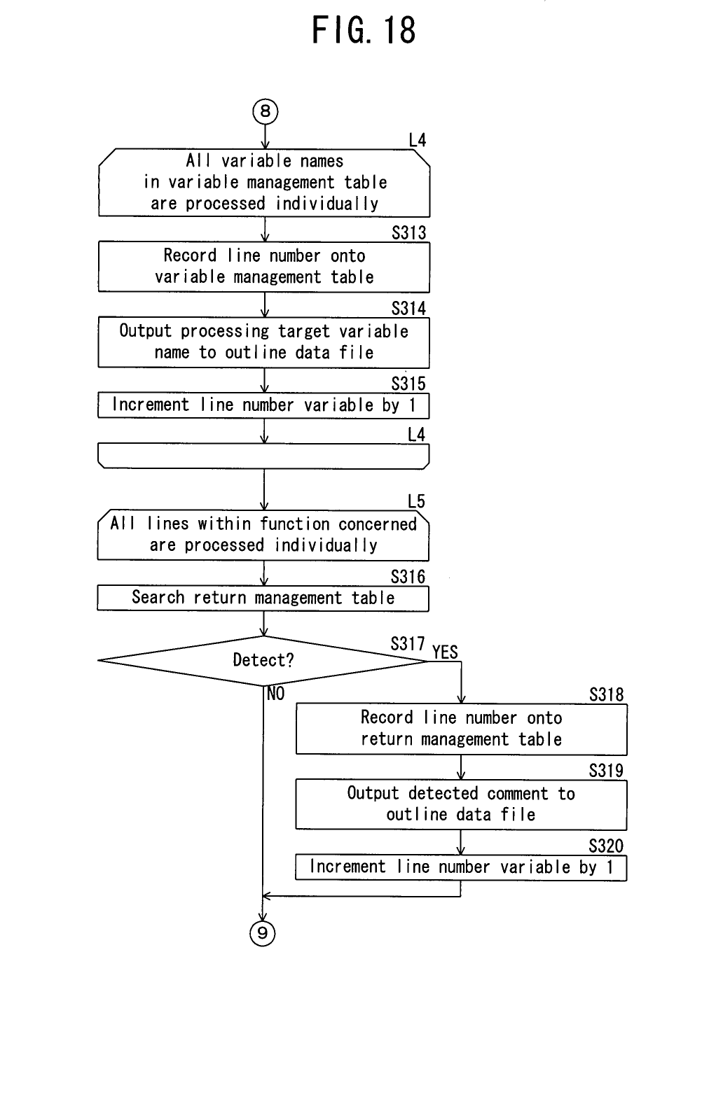

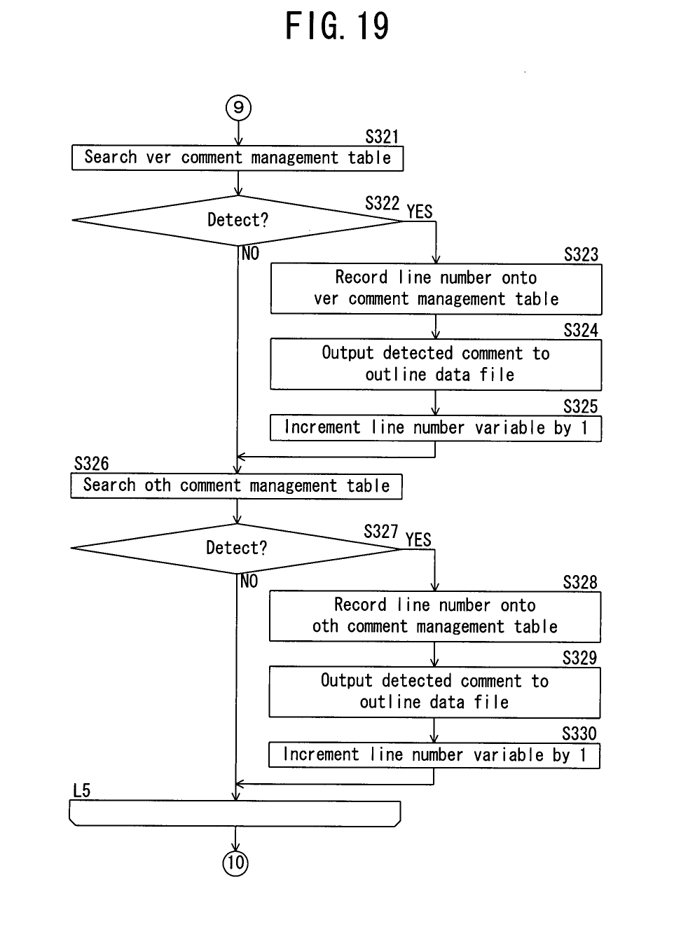

FIGS. 16 through 19 are flowcharts that represent the outline displaying process.

At first step S301 in the outline displaying process, the CPU 10d executes an initialization. In the initialization, zero is substituted into each of below-mentioned variables used in later processes. After executing the initialization, the CPU 10d executes a first process loop L1.

In the first process loop L1, the CPU 10d executes processes of steps S302 through S306 and second through fifth process loops L2 through L5 described below with respect to each of all the objects in the outline management table 28 in FIG. 15 individually.

First, in step S302, the CPU 10d determines whether the processing target object is a function. And when the processing target object is not a function, the CPU 10d branches the process from step S302 to step S303.

In step S303, the CPU 10d executes a process (not shown) according to the processing target object, and finishes the process with respect to the processing target object.

On the other hand, when the processing target object is a function in step S302, the CPU 10d advances the process to step S304 from step S302.

In step S304, the CPU 10d stores the substitution value of the line number variable into the “line number on outline” field of the record having the function name of the processing target in the outline management table 28 in FIG. 15.

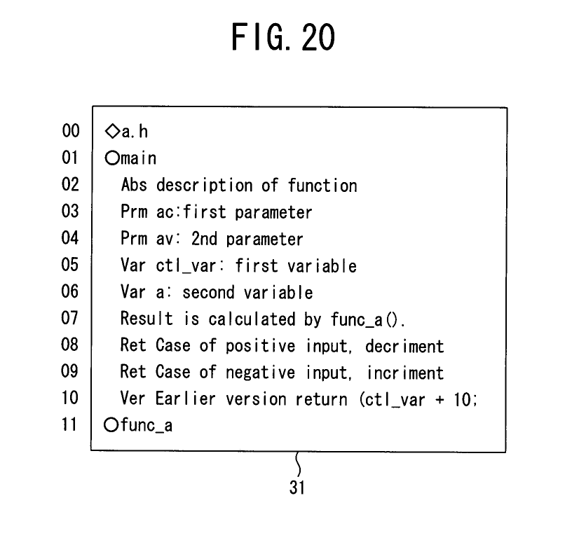

In the next step S305, the CPU 10d outputs the function name of the processing target to the outline data file. Outline data is the data for displaying outline on the outline display frame. FIG. 20 shows an example of the data structure of the outline data 31. The character string is described in each line of the outline data 31 as shown in FIG. 20. The CPU 10d outputs the function name of the processing target to the end line of the outline data 31.

In the next step S306, the CPU 10d increments the line number variable by one, and then, executes the second process loop L2.

In the second process loop L2, the CPU 10d executes processes of steps S307 through S309 described below with respect to each of all the abs comments in the abs comment management table 25 in FIG. 12 individually.

First, in step S307, the CPU 10d also stores the substitution value of the line number variable in the “line number of line including abs comment in outline” field of the record having the abs comment of the processing target in the abs comment management table 25 in FIG. 12.

In the next step S308, the CPU 10d outputs the abs comment of the processing target to the outline data file in FIG. 20. Specifically, the CPU 10d outputs the abs comment of the processing target to the end line of the outline data 31.

In the next step S309, the CPU 10d increments the line number variable by one, and then, finishes the process with respect to the processing target abs comment.

When the steps from S307 to S309 has been executed to all the abs comments, the CPU 10d exits from the second process loop L2, and starts the third process loop L3.

In the third process loop L3, the CPU 10d executes processes of steps S310 through S312 described below with respect to each of all the argument names in the argument management table 22 in FIG. 9.

First, in step S310, the CPU 10d stores the substitution value of the line number variable in the “line number of line including prm comment in outline” field of the record having the argument name of the processing target in the argument management table 22 in FIG. 9.

In the next step S311, the CPU 10d performs the process which outputs the prm comment of the processing target to the outline data file. Specifically, the CPU 10d outputs the prm comment of the processing target to the line of the end of outline data 31 in FIG. 20.

In the next step S312, the CPU 10d increments the substitution value of the line number variable by one, and finishes the process to the processing target argument name.

When the steps from S310 to S312 are executed to all the prm comments, the CPU 10d exits from the third process loop L3, and starts the fourth process loop L4.

In the fourth process loop L4, the CPU 10d executes processes of steps S313 through S315 described below with respect to each of all the variable names in the variable management table 23 in FIG. 10 individually.

First, in step S313, the CPU 10d stores the substitution value of the line number variable in the “line number of line including var comment in outline” field of the record having the variable name of the processing target in the variable management table 23 in FIG. 10.

In the next step S314, the CPU 10d outputs the var comment of the processing target to the outline data file. Specifically, the CPU 10d outputs the var comment of the processing target to the end line of the outline data 31 in FIG. 20.

In the next step S315, the CPU 10d increments the substitution value of the line number variable by one, and finishes the process to the processing target variable name.

When the steps from S310 to S312 has been executed to all the var comments, the CPU 10d exits from the fourth process loop L4, and starts the fifth process loop L5.

In the fifth process loop L5, the CPU 10d executes processes of steps S316 through S330 described below with respect to each line in all line groups (represented as a “function range”, hereinafter) that include function name of the processing target and function body thereof (contents included between a pair of curly brackets) individually.

First, in step S316, the CPU 10d searches the return management table 24 in FIG. 11 for a record whose “number of lines from line including function name to line including ret comment” field contains the line number of the processing target line within the function range concerned.

In the next step S317, the CPU 10d determines whether the record concerned has been detected from the return management table 24 in FIG. 11. When the CPU 10d cannot detect the record concerned from the return management table 24 in FIG. 11, the CPU 10d advances the process to step S321. When the record concerned is detected from the return management table 24 in FIG. 11, the CPU 10d branches the process from step S317 to step S318.

In step S318, the CPU 10d stores the substitution value of the line number variable into the “line number of line including ret comment in outline” field of the record of the processing target return in the return management table 24 in FIG. 11.

In the next step S319, the CPU 10d outputs the ret comment of the processing target to the end line of the outline data 31 in FIG. 20.

In the next step S320, the CPU 10d increments the substitution value of the line number variable by one. Then, the CPU 10d advances the process to step S321.

First, in step S321, the CPU 10d searches the ver comment management table 26 in FIG. 13 for a record whose “number of lines from line including function name to line including ver comment” field contains the line number of the processing target line within the function range concerned.

In the next step S322, the CPU 10d determines whether the record concerned has been detected from the ver comment management table 26 in FIG. 13. When the CPU 10d cannot detect the record concerned from the ver comment management table 26 in FIG. 13, the CPU 10d advances the process to step S326. When the record concerned is detected from the ver comment management table 26 in FIG. 13, the CPU 10d branches the process from step S322 to step S323.

Instep S323, the CPU 10d stores the substitution value of the line number variable into the “line number of line including ver comment in outline” field of the record of the processing target ver comment in the ver comment management table 26 in FIG. 13.

In the next step S324, the CPU 10d outputs the ver comment of the processing target to the end line of the outline data 31 in FIG. 20.

In the next step S325, the CPU 10d increments the substitution value of the line number variable by one. Then, the CPU 10d advances the process to step S326.

In step S326, the CPU 10d searches the oth comment management table 27 in FIG. 14 for a record whose “number of lines from line including function name to line including oth comment” field contains the line number of the processing target line within the function range concerned.

In the next step S327, the CPU 10d determines whether the record concerned has been detected from the oth comment management table 27 in FIG. 14. When the CPU 10d cannot detect the record concerned from the oth comment management table 27 in FIG. 14, the CPU 10d finishes the process with respect to the processing target lien. When the record concerned can be detected from oth comment management table 27 in FIG. 14, the CPU 10d branches the process from step S327 to step S328.

In step S328, the CPU 10d stores the substitution value of the line number variable in the “line number of line including oth comment in outline” field of the record of the oth comment of the processing target in oth comment management table 27 in FIG. 14.

In the next step S329, the CPU 10d outputs the oth comment of the processing target to the end line of the outline data 31 in FIG. 20.

In the next step S330, the CPU 10d increments the substitution value of the line number variable by one. Then, the CPU 10d finishes the process with respect to the processing target line.

When the steps from S316 to S330 have been executed to all the lines within the function range concerned, the CPU 10d exits from the fifth process loop L5.

When the steps from S302 to S306, and the second through fifth process loops L2 through L5 have been executed to all the function names in the outline management table 28 in FIG. 15, the CPU 10d exits from the first loop process loop L1 and advances the process to step S331.

In step S331, the CPU 10d displays an outline on the outline display frame based on the outline data 31 in FIG. 20. Then, the CPU 10d finishes the outline display process shown in FIGS. 16 through 19.

After finishing the outline display process, the CPU 10d returns the process to step S103 from step S107 in FIG. 3.

On the other hand, when the event is not an instruction to display an outline, the CPU 10d advances the process to step S108.

In step S108, the CPU 10d determines whether the event is a scroll instruction. And when the event is a scroll instruction, the CPU 10d branches the process from step S108 to step S109.

In step S109, the CPU 10d executes a scroll process.

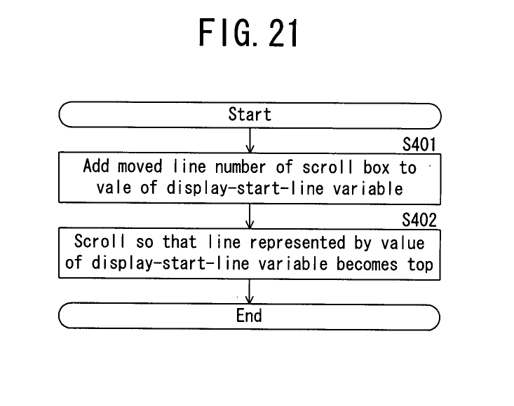

FIG. 21 is a flowchart showing a scroll process.

In a first step S401 of the scroll process, the CPU 10d adds a moved line number of a scroll (not shown) that is defined within the source code display frame to a substitution value of a display-start-line variable. The display-start-line variable shows a line number of a line in the source code that corresponds to the top line in the source code display frame. Since the source code after removing comments is displayed in the source code display frame, when adding the moved line number of the scroll (not shown) to the substitution value of the display-start-line variable, the CPU 10d also adds the number of comment-only-lines within a moving range of the scroll that is applied to the source code to the substitution value of the display-start-line variable.

In the next step S402, the CPU 10d scrolls the source code in the source code display frame so that the line represented by the substitution value of the display-start-line variable is displayed as the top line in the source code display frame. Then, the CPU 10d finishes the scroll process shown in FIG. 21.

After finishing the scroll process, the CPU 10d returns the process to step S103 from step S109 in FIG. 3.

On the other hand, when the event is not a scroll instruction in step S108, the CPU 10d advances the process to step S110.

In step S110, the CPU 10d determines whether the event is a drag instruction. When the event is the drag instruction, the CPU 10d branches the process from step S110 to step S111.

In step S111, the CPU 10d executes a drag-related process.

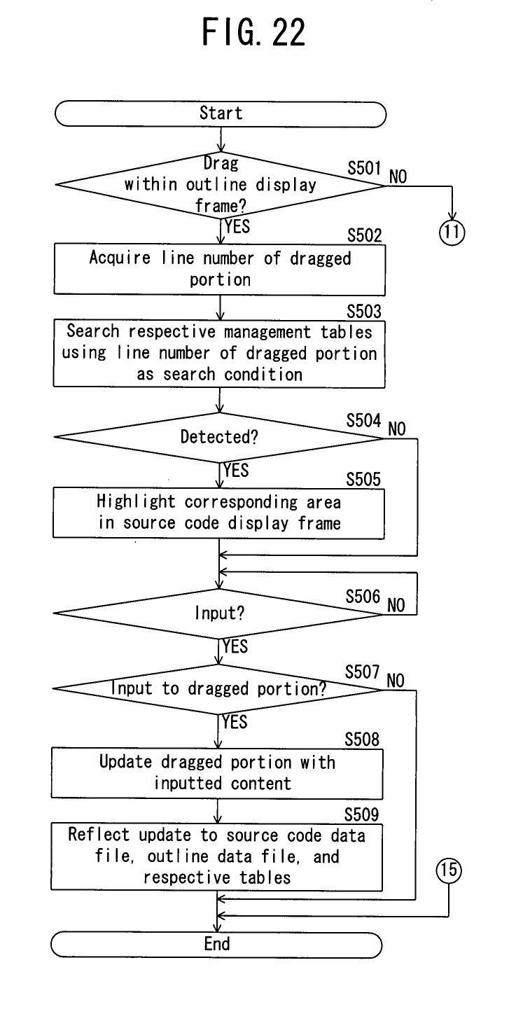

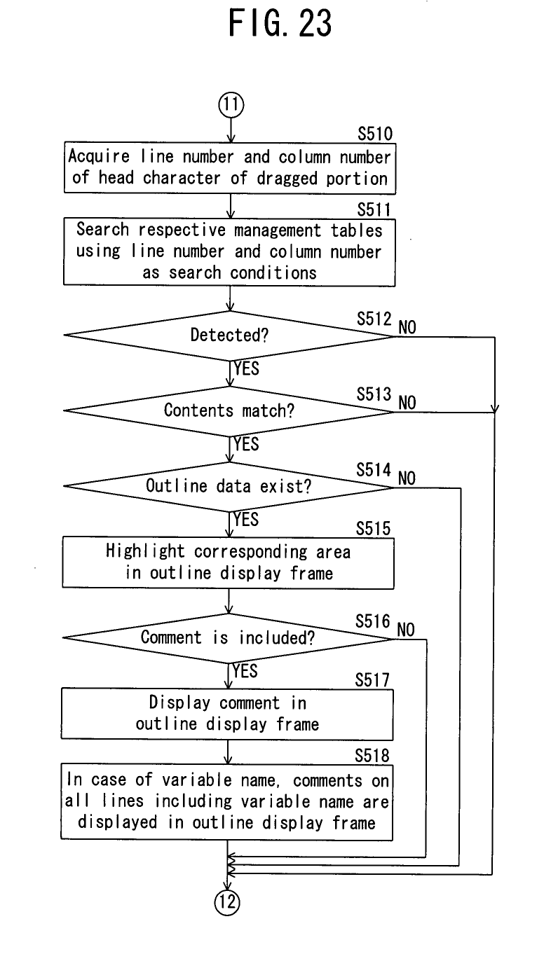

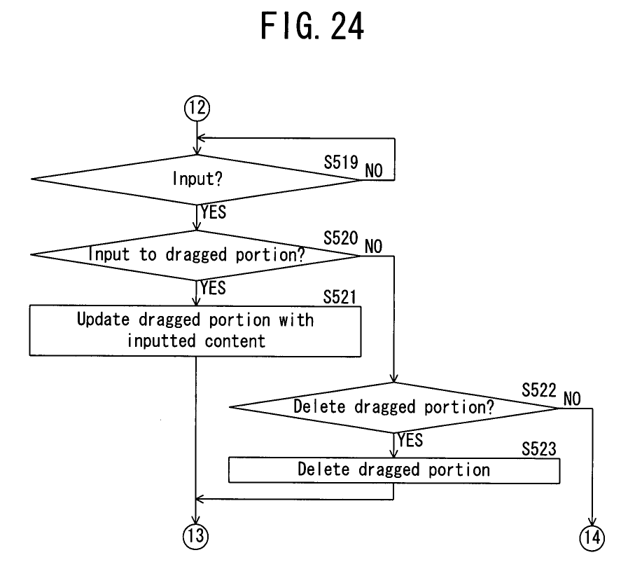

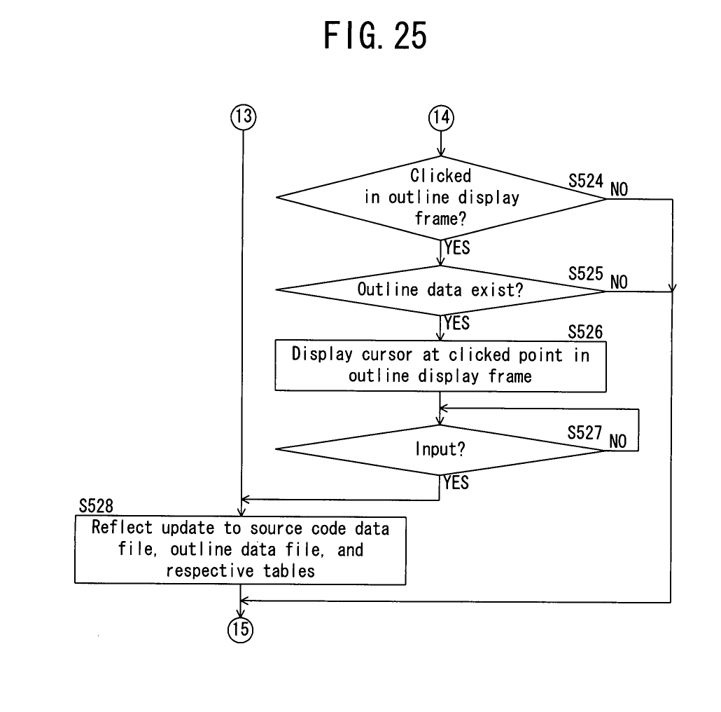

FIGS. 22 through 25 are flowcharts showing the drag-related process.

In a first step S501 of the drag-related process, the CPU 10d determines whether the dragged position is included within the outline display frame. When the dragged position is included in the outline display frame, the CPU 10d advances the process to step S502.

In step S502, the CPU 10d acquires the line number of the dragged portion (character string) in the outline. Specifically, the CPU 10d reads the number of lines from the top line to the dragged portion, reads the substitution value of the display-start-line variable that shows a line number of a line in the outline that corresponds to the top line in the outline display frame, and calculates the sum of both read values. Thereby, the CPU 10d acquires the line number of the dragged portion (character string) within the outline.

In the next step S503, the CPU 10d searches the tables 21 through 27 in FIGS. 8 through 14 based on the line number of the dragged portion (character string) in the outline as a search condition.

In the next step S504, the CPU 10d determines whether the record containing the line number of the dragged portion (character string) has detected from the tables 21 through 27 in FIGS. 8 through 14. When the record containing the line number of the dragged portion cannot be detected from any of the tables 21-27, the CPU 10d branches the process from step S504 to step S506. When the record containing the line number of the dragged portion is detected from any one of the tables 21-27, the CPU 10d advances the process to step S505.

In step S505, the CPU 10d highlights the area corresponding to the dragged portion in the source code display frame. For example, when a ret comment is dragged in the outline display frame, a corresponding return statement is highlighted in the source code display frame. For example, when a heading word (a function name, a variable name, etc.) is dragged in the outline display frame, a corresponding phrase (a function name, a variable name, etc.) is highlighted in the source code display frame. Then, the CPU 10d advances the process to step S506.

In step S506, the CPU 10d waits until receiving an input operation from the keyboard or the mouse. When any input operation is detected, the CPU 10d advances the process to step S507.

In step S507, the CPU 10d determines whether the input operation is directed to the dragged portion (for example, keystrokes or pasting for overwriting a character string, or cutoff for deleting a character string). And when the input operation is not directed to the dragged portion (for example, a left-click within the outline display frame), the CPU 10d cancels highlighting, branches the process from step S507, and finishes the drag-related process shown in FIGS. 22 through 24. On the other hand, when the input operation is directed to the dragged portion, the CPU 10d advances the process to step S508.

In step S508, the CPU 10d updates the contents of the dragged portion within the outline display frame by the inputted contents.

In the next step S509, the CPU 10d reflects the renewal contents of the dragged portion to the source code data in FIG. 2, to the outline data 31 in FIG. 20, and to the tables 21-27 in FIGS. 8 through 14. Then, the drag-related process shown in FIGS. 22 through 24 is finished.

On the other hand, when the dragged position is included in the source code display frame in step S501, the CPU 10d branches the process from step S501 to step S510.

The CPU 10d that executes steps S102, S110, and S501 corresponds to the above-mentioned accepting function and accepting section. Further, the steps S102, S110, and S501 correspond to the above-mentioned accepting procedure.

In step S510, the CPU 10d acquires the line number and column number of the head character of the dragged portion (character string).

In the next step S511, the CPU 10d searches the tables 21-24 in FIGS. 8 through 11 based on the line number and column number of the head character of the dragged portion (character string) as a search condition.

In the next step S512, the CPU 10d determines whether the record containing the line number and column number of the head character of the dragged portion has been detected from the tables 21 through 24 of FIGS. 8 through 11. When the record containing the line number and column number of the head character of the dragged portion cannot be detected from any of the tables 21-24, the CPU 10d branches the process from step S512 to step S519. When the record containing the line number and column number of the dragged portion is detected from any one of the tables 21-24, the CPU 10d advances the process to step S513.

In step S513, the CPU 10d reads a phrase (a function name, an argument name, or a variable name) containing the head character in the line number and column number concerned (but, the reading process is not executed for a record detected from the return management table 24), and determines whether the contents of the read phrase (or the return statement) are coincident with the contents of the dragged portion. When the contents of the read phrase and the dragged portion do not match, the CPU 10d branches the process from step S513 to step S519. When they match, the CPU 10d advances the process to step S514.

In step S514, the CPU 10d determines whether outline data in FIG. 20 has been created with respect to the source code data 12 read in step S202 in FIG. 4. That is, the CPU 10d determines whether outline data with respect to the source code data 12 concerned has been already created by executing step S107 in FIG. 3 at this time. When outline data has not been created, the CPU 10d branches the process from step S514 to step S519. On the other hand, when outline data has been created, the CPU 10d advances the process to step S515.

In step S515, the CPU 10d highlights the part corresponding to the dragged portion (phrases that contain the head character in the line number and column number concerned) within the outline display frame.

In the next step S516, the CPU 10d determines whether a comment is included in the record detected in step S512. When a comment is not included in the detected record, the CPU 10d branches the process from step S516 to step S519. When a comment is included in the detected record, the CPU 10d advances the process to step S517.

In step S517, the CPU 10d reads the position of the comment included in the detected record in step S512, and then, the CPU 10d displays the comment concerned at that position within the outline display frame. Since the coordinate in the source code display frame and the coordinate in the outline display frame scroll in conjugation with each other, the comment concerned is displayed within the outline display frame in the same line as the dragged portion in the source code display frame.

The CPU 10d that executes steps S510 through S514, S516, and S517 corresponds to the above-mentioned first displaying function and first displaying section. Further, steps S510 through S514, S516, and S517 correspond to the above-mentioned first displaying procedure.

In the next step S518, when a variable name is included in the record detected in step S512, the CPU 10d acquires the line numbers of all the lines in which the variable name is included in the source code data. Then, the CPU 10d searches the tables 21 through 27 in FIGS. 8 through 14 based on the acquired line numbers. As a result of the search, the CPU 10d also displays the comments included in all the detected records on the corresponding lines in the outline display frame. Then, the CPU 10d advances the process to step S519.

The CPU 10d that executes step S518 corresponds to the above-mentioned second displaying function and second displaying section. Further, step S518 corresponds to the above-mentioned second displaying procedure.

In step S519, the CPU 10d waits until receiving an input operation from the keyboard or the mouse. When any input operation is detected, the CPU 10d advances the process to step S520.

In step S520, the CPU 10d determines whether the input operation is directed to the dragged portion (for example, keystrokes or pasting for overwriting a character string, or cutoff for deleting a character string). And when the input operation is directed to the dragged portion, the CPU 10d advances the process to step S521.

In step S521, the CPU 10d updates the contents of the dragged portion in the source code display frame by the inputted contents. Then, the CPU 10d advances the process to step S528.

On the other hand, in step S520, when the input operation is not directed to the dragged portion made input is not the input to the drag portion (for example, a left-click within the source code display frame), the CPU 10d branches the process from step S520 to step S522.

In step S522, the CPU 10d determines whether the input operation means a deletion of the dragged portion (push down of a deletion key). And when the input operation means a deletion of the drag portion, the CPU 10d advances the process to step 523.

In step S523, the CPU 10d deletes the dragged portion from the source code display frame. Then, the CPU 10d advances the process to step S528.

On the other hand, in step S522, when the input operation does not mean a deletion of the dragged portion, the CPU 10d branches the process from step S522 to step S524.

In step S524, the CPU 10d determines whether the input operation is a click within the outline display frame. And when the input operation is a click in the outline display frame, the CPU 10d advances the process to step S525.

In step S525, the CPU 10d determines whether the outline data in FIG. 20 has been created with respect to the source code data 12 read in step S202 in FIG. 4. When the outline data has been created, the CPU 10d advances the process to step S526.

In step S526, the CPU 10d displays a cursor on the line that includes the comment corresponding to the dragged portion within the outline display frame.

In the next step S527, the CPU 10d waits until an input of a character string at the cursor position in the outline display frame is completed. And if the input of the character string is completed, the CPU 10d advances the process to step S528.

In step S528, the CPU 10d reflects the renewal of contents or deletion of the dragged portion to the source code data in FIG. 2, and to the tables in FIGS. 8 through 14. Alternatively, when a character string is inputted in the outline display frame, the CPU 10d reflects the character string to the source code data in FIG. 2, to the outline data in FIG. 20, and to the tables 21 through 27 in FIGS. 8 through 14. The character string is reflected as a comment in the source code and as being linked with the character string in the dragged portion. Then, the CPU 10d finishes the drag-related process shown in FIGS. 22 through 25.

When the input operation is not a click within the outline display frame in step S524, or when the outline data has not been created in step S525, the CPU 10d branches the process from step S524 or S525, cancels the dragged hihglights in the source code display frame, and finishes the drag-related process shown in FIGS. 22 through 25.

After processing the drag-related process, the CPU 10d returns the process to step S103 from step S111 in FIG. 3.

On the other hand, when the event is not a drag in step S110, the CPU 10d advances the process to step S112.

In step S112, the CPU 10d determines whether the event is a finish instruction. And when the event is not a finish instruction, the CPU 10d branches the process from step S112 to step S113.

In step S113, the CPU 10d executes a process in response to the event. For example, the CPU 10d directs to execute a process selected among a file menu or an edit menu, or directs to execute a process selected among a popup menu displayed by a right click. When the event is the click of the source code display frame, the CPU 10d performs the process which displays the cursor on the clicking point, in order to be able to perform the keystroke for inputting new source code into the clicking point. After executing the processes, the CPU 10d returns the process to step S103.

On the other hand, when the event is a finish instruction in step S112, the CPU 10d finishes the process shown in FIG. 3.

Next, the operations and effects of the embodiment will be described.

An operator using the software development device 10 starts the software development tool 13 and opens any file of source code data 12 by operating the input devices 10b (steps S101 through S103). Then, the tables 21 through 28 shown in FIGS. 8 through 15 are created with respect to the source code data 12, and the source code is displayed on the source code display frame after removing comments (step S104; YES, S105, S201 through S235). After that, when the operator directs to display an outline, various kinds of comments in the source code are registered into the tables 22 through 27 shown in FIGS. 9 through 14, and the outline data for displaying outline on the outline display frame is generated. The outline is displayed in the outline display frame based on the outline data (step S106; YES, S107, S301 through S331).

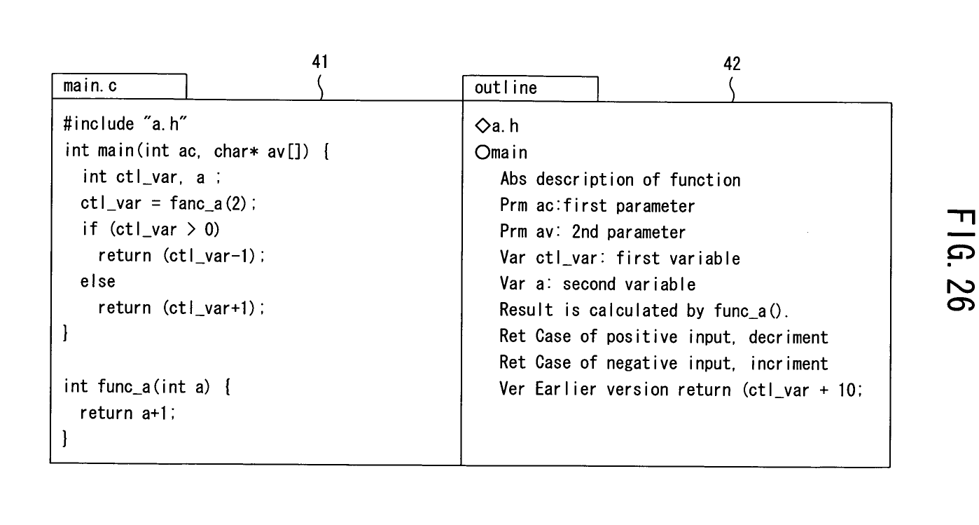

FIG. 26 shows the source code based on the source code data 12 in FIG. 2 and the outline of the source code are displayed in the source code display frame 41 and the outline display frame 42, respectively. As shown in FIG. 26, the comments that are included in the source code data 12 shown in FIG. 2 are not displayed in the source code display frame 41. Instead, these comments are displayed in the outline display frame 42.

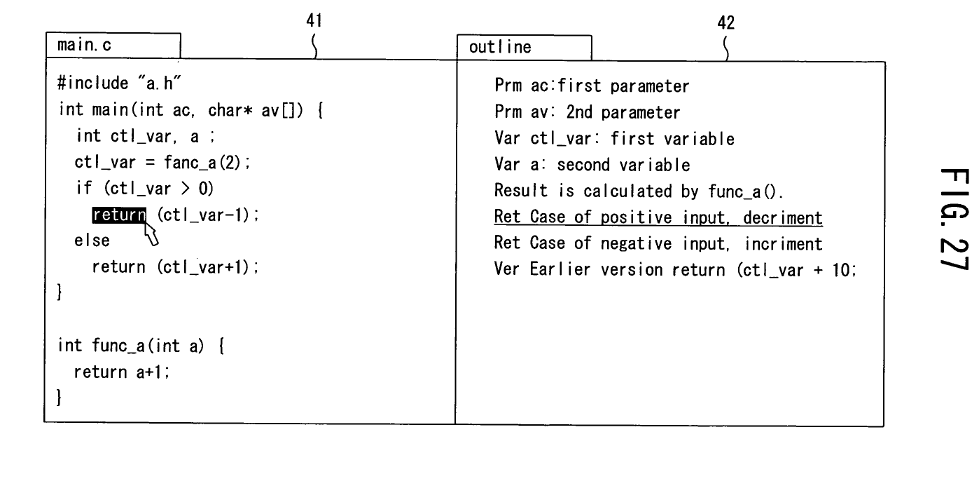

In the work screen that includes such display frames 41 and 42 as shown in FIG. 27, it is assumed that the operator drags a character string “return” in the source code display frame 41 (step S110; YES, S501; NO). Since the head character of the return statement is included in the fourth column of the eighth line in the source code, the position of the ret comment in the outline is specified by the line number “8” and the column number “4” with reference to the return management table 24 in FIG. 11 (step S510, S511, S512; YES, S513; YES, S514; YES). Then, the ret comment located at the specified position is highlighted as shown in FIG. 27 (step S515). Since the coordinate in the source code display frame and the coordinate in the outline display frame scroll in conjugation with each other, the comment concerned is displayed within the outline display frame in the same line as the dragged portion in the source code display frame.

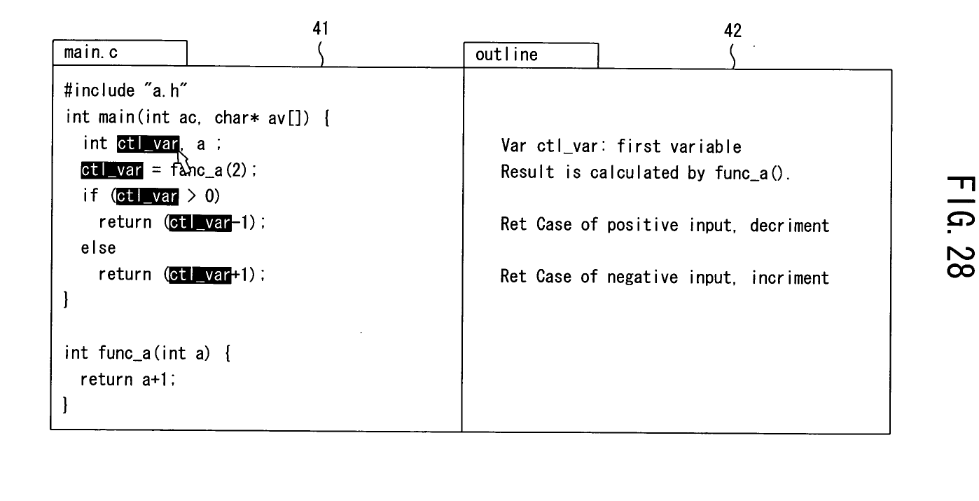

Further, when the operator drags a variable name “ctl_var” in the source code display frame 41, under the condition where the source code is displayed in the source code display frame 41 but the outline is not displayed in the outline display frame 42, the position of the var comment in the outline is specified based on the line number “2” and the column number “6” of the head character of the variable name with reference to the variable management table 23 in FIG. 10 (step S510, S511, S512; YES, S513; YES, S514; NO, S516; YES). As shown in FIG. 28, the var comment is displayed at the specified position in the outline display frame (step S517), and the comments included in all the lines containing “ctl_var” in the source code display frame 41 are also displayed in the outline display frame 42 (step S518).

Therefore, according to the software development device 10, the source code can be displayed in the source code display frame 41 under the condition where the comments are removed. Further, when any portion in the displayed source code is dragged, a comment related to the dragged portion is displayed in the outline display frame 42. As a result, comments do not interfere with a confirmation of logic of a source code and the comments can be used effectively.

What is claimed is:

1. A source code displaying program that makes a computer execute functions comprising:
a reading function for reading, when a source code is designated among source codes that contain statements and comments through an input device, data of the designated source code from storage;
an information creating function for creating relation information that relates a comment to a token associated with the comment for each of comments in said source code shown by the source code data read from said storage by said reading function, and for storing the created relation information into said storage;
a source code displaying function for displaying a source code after removing comments in a first display frame based on said source code data read from said storage by said reading function;
an accepting function for accepting a designation about any selected portion of the source code displayed in said first display frame by said source code displaying function, through said input device; and
a first displaying function for reading, when the portion specified by the designation accepted by said accepting function is coincident with any token in said storage, the comment associated with this token from said storage, and for displaying the comment at a position corresponding to the position of the portion concerned in a second display frame.

2. The source code displaying program according to claim 1, wherein said information creating function creates relation information that relates a comment, a token associated with the comment, and a position information that represents the position of said comment in the source code and stores the created relation information into said storage,
further comprising: a second displaying function for extracting portions that have the same contents as the designated portion from said source code, acquiring position information that represents the position of the portion in said source code, reading comments that have the same position information as the acquired position information from said storage, and displaying the comments at the corresponding positions in said second display frame.

3. A computer readable medium storing a source code displaying program that makes a computer execute functions comprising:
a reading function for reading, when a source code is designated among source codes that contain statements and comments through an input device, data of the designated source code from storage;
an information creating function for creating relation information that relates a comment to a token associated with the comment for each of comments in said source code shown by the source code data read from said storage by said reading function, and for storing the created relation information into said storage;
a source code displaying function for displaying a source code after removing comments in a first display frame based on said source code data read from said storage by said reading function;
an accepting function for accepting a designation about any selected portion of the source code displayed in said first display frame by said source code displaying function, through said input device; and
a first displaying function for reading, when the portion specified by the designation accepted by said accepting function is coincident with any token in said storage, the comment associated with this token from said storage, and for displaying the comment at a position corresponding to the position of the portion concerned in a second display frame.

4. The computer readable medium according to claim 3, wherein said information creating function creates relation information that relates a comment, a token associated with the comment, and a position information that represents the position of said comment in the source code and stores the created relation information into said storage,
further comprising: a second displaying function for extracting portions that have the same contents as the designated portion from said source code, acquiring position information that represents the position of the portion in said source code, reading comments that have the same position information as the acquired position information from said storage, and displaying the comments at the corresponding positions in said second display frame.

5. A source code displaying device comprising: a reading section for reading, when a source code is designated among source codes that contain statements and comments through an input device, data of the designated source code from storage;
an information creating section for creating relation information that relates a comment to a token associated with the comment for each of comments in said source code shown by said source code data read from said storage by said reading section, and for storing the created relation information into said storage;
a source code displaying section for displaying a source code after removing comments in a first display frame based on said source code data read from said storage by said reading section;
an accepting section for accepting a designation about any selected portion of the source code displayed in said first display frame by the source code displaying section, through said input device; and
a first displaying section for reading, when the portion specified by the designation accepted by said accepting section is coincident with any token in said storage, the comment associated with this token from said storage, and for displaying the comment at a position corresponding to the position of the portion concerned in a second display frame.

6. The source code displaying device according to claim 5, wherein said information creating section creates relation information that relates a comment, a token associated with the comment, and a position information that represents the position of said comment in the source code and stores the created relation information into said storage, further comprising: a second displaying section for extracting portions that have the same contents as the designated portion from said source code, acquiring position information that represents the position of the portion in said source code, reading comments that have the same position information as the acquired position information from said storage, and displaying the comments at the corresponding positions in said second display frame.

7. A source code displaying method that is implemented by a computer that executes procedures comprising:
a reading procedure for reading, when a source code is designated among source codes that contain statements and comments through an input device, data of the designated source code from storage;
an information creating procedure for creating relation information that relates a comment to a token associated with the comment for each of comments in the source code shown by the source code data read from said storage by said reading procedure, and for storing the created relation information into said storage;
a source code displaying procedure for displaying a source code after removing comments in a first display frame based on the source code data read from said storage by said reading procedure;
an accepting procedure for accepting a designation about any selected portion of the source code displayed in said first display frame by said source code displaying procedure, through said input device; and
a first displaying procedure for reading, when the portion specified by the designation accepted by said accepting procedure is coincident with any token in said storage, the comment associated with this token from said storage, and for displaying the comment at a position corresponding to the position of the portion concerned in a second display frame.

8. The source code displaying method according to claim 7, wherein said information creating procedure creates relation information that relates a comment, a token associated with the comment, and a position information that represents the position of said comment in the source code and stores the created relation information into said storage,
further comprising: a second displaying procedure for extracting portions that have the same contents as the designated portion from said source code, acquiring position information that represents the position of the portion in said source code, reading comments that have the same position information as the acquired position information from said storage, and displaying the comments at the corresponding positions in said second display frame.
